(19) United States
(12) Patent Application Publication
(10) Pub. No.: US 2013/0169216 A1
(43) Pub. Date: Jul. 4, 2013

(54) CHARGING SYSTEM, BASE-STATION APPARATUS, DATA RELAY APPARATUS, CHARGING-INFORMATION PROCESSING APPARATUS, CHARGING-INFORMATION GENERATING APPARATUS, AND CHARGING-INFORMATION MODIFYING METHOD

(71) Applicant: FUJITSU LIMITED, Kawasaki (JP)

(72) Inventor: Koji Tsubouchi, Yamato (JP)

(73) Assignee: FUJITSU LIMITED, Kawasaki (JP)

(21) Appl. No.: 13/692,473

(22) Filed: Dec. 3, 2012

(30) Foreign Application Priority Data
Dec. 28, 2011 (JP) 2011-289702

(51) Int. Cl. H02J 7/00

(52) U.S. Cl. CPC H02J 7/00
USPC 320/107

(57) ABSTRACT

A charging system includes a base-station apparatus, a data relay apparatus, and a charging-information generating apparatus. The base-station apparatus generates first non-forwardable-data information regarding data forwarded via at least the charging-information generating apparatus and not forwarded by the base-station apparatus, the data relay apparatus includes generates second non-forwardable-data information regarding data forwarded via at least the charging-information generating apparatus and not forwarded by the data relay apparatus, the charging-information generating apparatus generates charging information based on data forwarded by the charging-information generating apparatus, and the charging information is modified based on at least one of the first non-forwardable-data information and the second non-forwardable-data information.

### CROSS-REFERENCE TO RELATED APPLICATION

This application is based upon and claims the benefit of priority of the prior Japanese Patent Application No. 2011-289702, filed on Dec. 28, 2011, the entire contents of which are incorporated herein by reference.

### FIELD

The embodiments discussed herein are related to a charging system, a base-station apparatus, a data relay apparatus, a charging-information processing apparatus, a charging-information generating apparatus, and a charging-information modifying method.

### BACKGROUND

An example of a mobile communications network that includes a packet exchange network is a mobile communications network that includes a base-station apparatus, a packet relay apparatus, and a charging-information generating apparatus. In the mobile communications network, data transmission and reception are performed between a mobile terminal apparatus, such as a mobile phone, and a counterparty communication apparatus via the base-station apparatus, the packet relay apparatus, the charging-information generating apparatus, and so on.

As one type of control performed by a packet exchange network in such a mobile communications network, there is charging control. With charging control, the charging-information generating apparatus records, to a CDR (charging data record), information about a user's network traffic that passes through the charging-information generating apparatus, and transmits the CDR to the charging-information processing apparatus at a billing center, as appropriate. The CDR is a file in which charging information is recorded and the charging-information generating apparatus generates a CDR for each bearer, where bearer is a term that refers to a logical communication path. The charging information contains, for example, information about a subscriber identifier (for example, international mobile subscriber identity (IMSI)), charging-recording start time, the charging-recording period, and the pass data volume. The charging-information processing apparatus at the billing center performs, for example, creation of detailed billing data for a user (for example, a subscriber of a mobile phone company) of a mobile terminal apparatus, based on the charging information recorded in the received CDR, where the mobile terminal apparatus corresponds to the received CDR.

With the charging control performed as described above, there are two types of charging control. One of the types is bearer-level control that records the charging information to a CDR for each bearer. The other type is service-flow-level charging control that separately measures and records the charging information in one CDR for each service flow identified by policy and charging control (PCC) used for a bearer. A service flow is identified based on information such as a transmission-source address, a transmission-source port, a destination address, a destination port, and a protocol identifier (ID) that are contained in the header of a packet. The PCC used for the bearer is reported from a policy and charging rules function (PCRF) to the charging-information generating apparatus. However, the PCC is not reported to the packet relay apparatus and the base-station apparatus.

Technologies described below are available as technology for the charging control performed in a communications network. For example, there is a technology in which a usage-based charging apparatus charges a transmission source a usage-based fee that corresponds to the amount of network usage. In a charging system, there is also a technology in which charging is performed according to a received data volume when broadcast service is performed. There is also a technology in which a distribution server performs charging according to a communication failure, such as a line disconnection. There is also a technology in which, in a data transmission charging system, data units are forwarded at given intervals and charging processing is performed using timing signals generated in response to the data units.

Examples of the related art include International Publication Pamphlet No. WO 02/30048, Japanese Laid-open Patent Publication No. 2010-93340, Japanese Laid-open Patent Publication No. 2002-164955, and Japanese Laid-open Patent Publication No. 8-293862.

### SUMMARY

According to an aspect of the invention, a charging system includes a base-station apparatus, a data relay apparatus, and a charging-information generating apparatus, the base-station apparatus generates first non-forwardable-data information regarding data forwarded via at least the charging-information generating apparatus and not forwarded by the base-station apparatus, the data relay apparatus includes generates second non-forwardable-data information regarding data forwarded via at least the charging-information generating apparatus and not forwarded by the data relay apparatus, the charging-information generating apparatus generates charging information based on data forwarded by the charging-information generating apparatus, and the charging information is modified based on at least one of the first non-forwardable-data information and the second non-forwardable-data information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a charging system;

FIG. 2 illustrates an example of charging information recorded in a CDR;

FIG. 3 illustrates an example of packet drop (packet loss) that can occur in the charging system;

FIG. 4 illustrates an example of a scheme, in the charging system, for modifying the charging information;

FIG. 5 illustrates an example of the configuration of a base-station apparatus, a packet relay apparatus, a charging-information generating apparatus, and a charging-information processing apparatus in the charging system that realizes the charging-information modifying scheme;

FIG. 6 is a flowchart illustrating an example of operations performed by the base-station apparatus and the packet relay apparatus;

FIG. 7 is a flowchart illustrating an example of an operation performed by the charging-information processing apparatus;

FIG. 8 illustrates an example in which the charging system is applied to a communications network that includes an E-UTRAN and an EPC network;

FIG. 9 illustrates an example in which the charging system is applied to a communications network that includes a UTRAN and a GPRS network;

FIG. 10 illustrates an example in which the charging system is applied to a communications network that includes a UTRAN, a GPRS network, and an EPC network;

FIG. 11 illustrates an example of a charging system employing another method conceived as a scheme for modifying the charging information by using CDRs;

FIG. 12 illustrates an example of a scheme, in the charging system, for modifying the charging information;

FIG. 13 illustrates an example of a configuration of the base-station apparatus;

FIG. 14 illustrates an example of a configuration of the packet relay apparatus;

FIG. 15 illustrates an example of a configuration of the charging-information generating apparatus;

FIG. 16 is a flowchart illustrating an example of operations performed by the base-station apparatus;

FIG. 17 is a flowchart illustrating an example of operations performed by the packet relay apparatus;

FIG. 18 is a flowchart illustrating an example of operations performed by the charging-information processing apparatus;

FIG. 19 illustrates an example in which the charging system is applied to a communications network that includes an E-UTRAN and an EPC network;

FIG. 20 illustrates an example in which the charging system is applied to a communications network that includes a UTRAN and a GPRS network;

FIG. 21 illustrates an example in which the charging system is applied to a communications network that includes a UTRAN, a GPRS network, and an EPC network; and

FIG. 22 illustrates an example of a configuration of a computer.

### DESCRIPTION OF EMBODIMENTS

Hereinafter, embodiments will be described. It is noted that combinations of configurations according to respective embodiments are also included in the embodiments.

While inventing the present embodiments, observations were made regarding a related art. Such observations include the following, for example.

In a mobile communications network of the related art, there are cases in which a downlink packet (a “DL packet”) that has passed through a charging-information generating apparatus does not reach a mobile terminal apparatus for reasons such as the following. For example, at a packet relay apparatus or a base-station apparatus that received the DL packet, the DL packet is dropped due to an internal factor of the apparatus, such as overflow of a packet-forwarding buffer memory. Alternatively, for example, at the packet relay apparatus or the base-station apparatus that received the DL packet, the DL packet is not forwardable because no relevant session exists due to an inter-apparatus-state mismatch, such as the absence of routing information for the transmission destination of the packet. In such a case, an unforwardable packet is unavoidably dropped.

Thus, even when a DL packet that passed through the charging-information generating apparatus does not actually reach the mobile terminal apparatus, the charging-information generating apparatus records the charging information for the packet in a CDR. In such a case, with the new way of thinking that a packet that has not actually reached the mobile terminal apparatus is not to be charged, the CDR contains erroneous charging information. A scheme for inhibiting such erroneous charging is not presently available for charging control defined by the 3rd Generation Partnership Project (3GPP).

There has been a technical idea for ensuring that no packet is dropped at the packet relay apparatus and the base-station apparatus. However, there has been no technical idea for ensuring that no charge is issued for a packet that has not actually reached the mobile terminal apparatus because packet was dropped at the packet relay apparatus or the base-station apparatus.

### First Embodiment

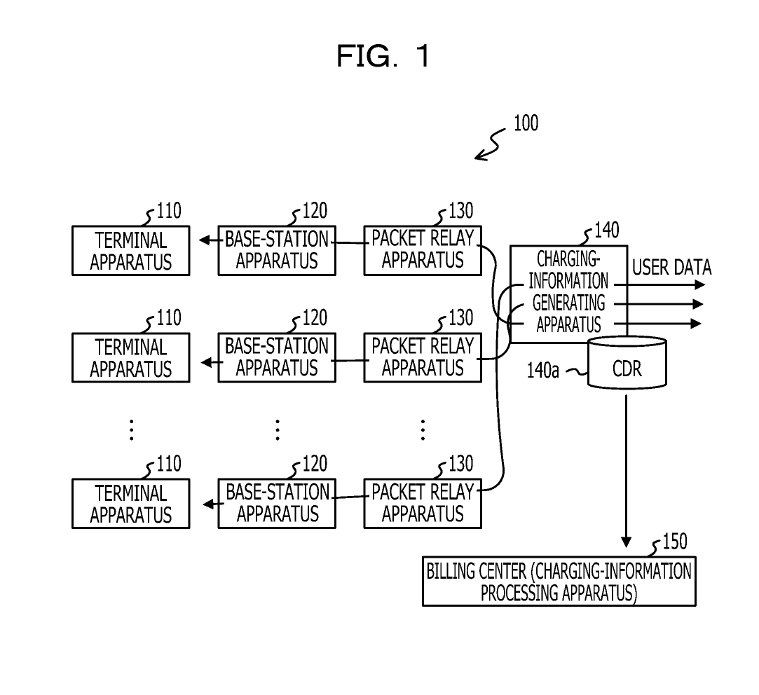

FIG. 1 is a block diagram illustrating an example of a charging system according to a first embodiment.

The charging system according to the first embodiment is included in, for example, a packet exchange network in a mobile communications network. In the charging system according to the present embodiment, bearer-level charging control is performed.

As illustrated in FIG. 1, a charging system 100 according to the present embodiment includes terminal apparatuses 110, base-station apparatuses 120, packet relay apparatuses 130, a charging-information generating apparatus 140, and a charging-information processing apparatus 150 that is placed at a billing center. A packet relay apparatus 130 is an example of a data relay apparatus.

In the charging system 100, for example, transmission and reception of packets (user data) are performed between each terminal apparatus 110 and an apparatus (not illustrated) at another end of communication via the corresponding base-station apparatus 120, the corresponding packet relay apparatus 130, and the charging-information generating apparatus 140.

Each terminal apparatus 110 is, for example, a mobile terminal apparatus, such as a mobile phone.

Each of the base-station apparatus 120 and the packet relay apparatus 130 performs tasks such as forwarding packets.

The charging-information generating apparatus 140 performs, for example, packet forwarding, generation of charging information, generation of a CDR 140a, and transmission of the CDR 140a, in which the charging information is recorded, to the charging-information processing apparatus 150. A CDR 140a is generated for each bearer.

The charging-information processing apparatus 150 performs, for example, creation of detailed billing data based on the charging information recorded in each CDR 140a transmitted from the charging-information generating apparatus 140.

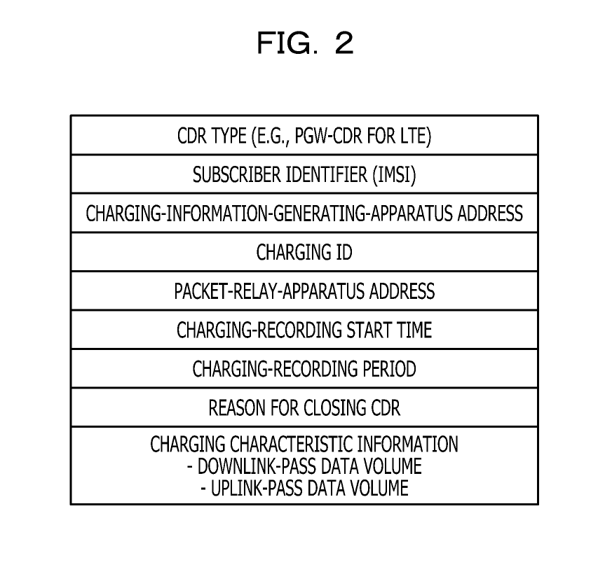

FIG. 2 illustrates an example of the charging information recorded in a CDR 140a.

As illustrated in FIG. 2, the charging information recorded in a CDR 140a contains information about a CDR type, a subscriber identifier (IMSI), a charging-information-generating-apparatus address, a charging ID (identification), and a packet-relay-apparatus address. The charging information recorded in the CDR 140a further contains information regarding charging-recording start time, a charging-recording period, a reason for closing the CDR, and charging characteristic information.

The CDR type represents the type of CDR. For example, when the charging system 100 is a system that supports long term evolution (LTE), the CDR type is a packet data network gateway (PGW) CDR. The subscriber identifier is assigned to a user of the terminal apparatus 110 that has communicated using a bearer corresponding to the CDR 140a. The charging-information-generating-apparatus address is an address of the charging-information generating apparatus 140. The charging ID is an identifier of the CDR 140a. The packet-relay-apparatus address is an address of the packet relay apparatus 130 that is used by the bearer corresponding to the CDR 140a. The charging-recording start time is the approximate time when the bearer corresponding to the CDR 140a is established. The charging-recording period is the length of time from the charging-recording start time to the time that the CDR 140a is closed. The reason for closing the CDR is the reason why the CDR 140a is closed. For example, one reason is that the packet relay apparatus 130 used for communication is changed or otherwise affected as a result of movement of the terminal apparatus 110. The charging characteristic information contains a downlink-pass data volume and an uplink-pass data volume. The information regarding the downlink-pass data volume represents, on the bearer corresponding to the CDR 140a, the data volume of DL packets (data addressed to the terminal apparatus 110) that passed through the charging-information generating apparatus 140. The information regarding the uplink-pass data volume represents, for the bearer corresponding to the CDR 140a, the data volume of uplink packets (each a “UL packet”) that passed through the charging-information generating apparatus 140.

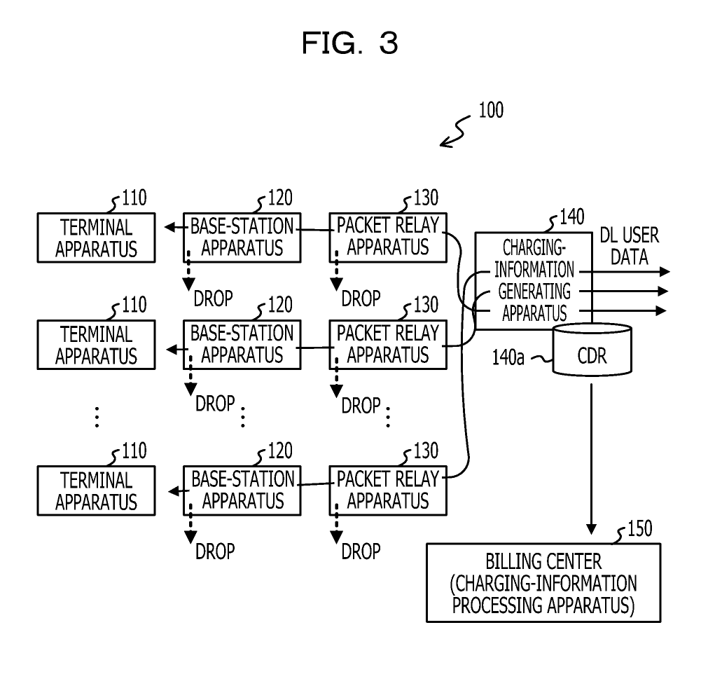

FIG. 3 illustrates an example of packet drop (packet loss) that can occur in the charging system 100.

As illustrated in FIG. 3, in the charging system 100, there are cases in which a DL packet that passed through the charging-information generating apparatus 140 is dropped at the base-station apparatus 120 or the packet relay apparatus 130 for the following reasons. For example, there is a case in which, at the packet relay apparatus 130 or the base-station apparatus 120 that has received the DL packet, the DL packet is dropped due to an internal factor of the apparatus, such as overflow of a packet-forwarding buffer memory. Additionally, for example, there is a case in which, at the packet relay apparatus 130 or the base-station apparatus 120 that has received the DL packet, the DL packet is dropped since no relevant session exists due to an inter-apparatus-state mismatch. The case in which no relevant session exists due to an inter-apparatus-state mismatch is, for example, a case in which routing information regarding the transmission destination of the packet does not exist.

In cases such as above, the DL packet that passed through the charging-information generating apparatus 140 does not reach the terminal apparatus 110. In such cases, in a related art system, the packet is also charged. In contrast, when the DL packet is dropped due to an internal factor of at least the packet relay apparatus 130 or the base-station apparatus 120, the charging system 100 according to the present embodiment is adapted to modify the charging information so that the packet is not charged.

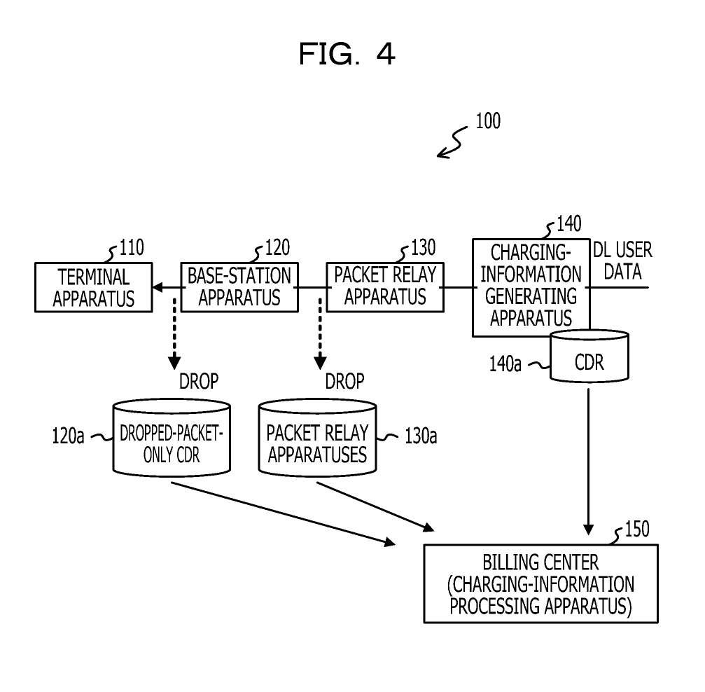

FIG. 4 illustrates an example of a scheme, in the charging system 100, for modifying the charging information.

As illustrated in FIG. 4, the base-station apparatus 120 is adapted to record dropped-packet information, which is information about dropped DL packets, to a dropped-packet-only CDR 120a. The dropped-packet information is an example of non-forwardable-data information. The dropped-packet-only CDR 120a is a file to which dropped-packet information is to be recorded and is an example of a non-forwardable-data CDR that is a file in which non-forwardable-data information is recorded. A dropped-packet-only CDR 120a is generated for each bearer corresponding to the DL packet dropped at the base-station apparatus 120, based on relevant session information. Thus, a dropped-packet-only CDR 120a is not generated for a bearer from which no DL packet was dropped at the base-station apparatus 120. The session information is managed by the base-station apparatus 120. The format of the CDR 140a generated by the charging-information generating apparatus 140 may also be used as the format of the dropped-packet-only CDR 120a. In this case, however, information recorded in the dropped-packet-only CDR 120a is, for example, modified in the following points with respect to the information recorded in the CDR 140a illustrated in FIG. 2. First, instead of the information regarding the downlink-pass data volume illustrated in FIG. 2, the information recorded in the dropped-packet-only CDR 120a contains information about the data volume of DL packets dropped at the base-station apparatus 120 on the bearer corresponding to the dropped-packet-only CDR 120a. Instead of the charging-information-generating-apparatus address illustrated in FIG. 2, the information recorded in the dropped-packet-only CDR 120a contains the address of the base-station apparatus 120. The base-station apparatus 120 is further adapted to transmit, to the charging-information processing apparatus 150, each dropped-packet-only CDR 120a in which dropped-packet information is recorded, as appropriate.

A similar situation also applies to the packet relay apparatus 130. That is, the base-station apparatus 130 is adapted to record dropped-packet information, which is information about dropped DL packets, in a dropped-packet-only CDR 130a. The dropped-packet information is an example of non-forwardable-data information. The dropped-packet-only CDR 130a is a file to which dropped-packet information is recorded and is an example of a non-forwardable-data CDR that is a file in which non-forwardable-data information is recorded. A dropped-packet-only CDR 130a is generated for each bearer corresponding to DL packets dropped at the packet relay apparatus 130, based on relevant session information. Thus, a dropped-packet-only CDR 130a is not generated for a bearer from which no DL packet was dropped at the packet relay apparatus 130. The session information is managed by the packet relay apparatus 130. The format of the CDR 140a generated by the charging-information generating apparatus 140 may also be used as the format of the dropped-packet-only CDR 130a. In this case, however, information recorded in the dropped-packet-only CDR 130a is modified, for example, in the following points with respect to the information recorded in the CDR 140a illustrated in FIG. 2. First, instead of the information regarding the downlink-pass data volume illustrated in FIG. 2, the information recorded in the dropped-packet-only CDR 130a contains information regarding the data volume of DL packets dropped at the packet relay apparatus 130 on the bearer corresponding to the dropped-packet-only CDR 130a. In addition, instead of the charging-information-generating-apparatus address illustrated in FIG. 2, the information recorded in the dropped-packet-only CDR 130a also contains the address of the packet relay apparatus 130. The packet relay apparatus 130 is further adapted to transmit, to the charging-information processing apparatus 150, each dropped-packet-only CDR 130a in which the dropped-packet information is recorded, as appropriate.

The charging-information processing apparatus 150 is adapted to receive each dropped-packet-only CDR 120a transmitted from the base-station apparatus 120 and each dropped-packet-only CDR 130a transmitted from the packet relay apparatus 130. The charging-information processing apparatus 150 is also adapted to modify the charging information recorded in each CDR 140a transmitted from the charging-information generating apparatus 140, based on the dropped-packet information recorded in one or both of the dropped-packet-only CDRs 120a and 130a.

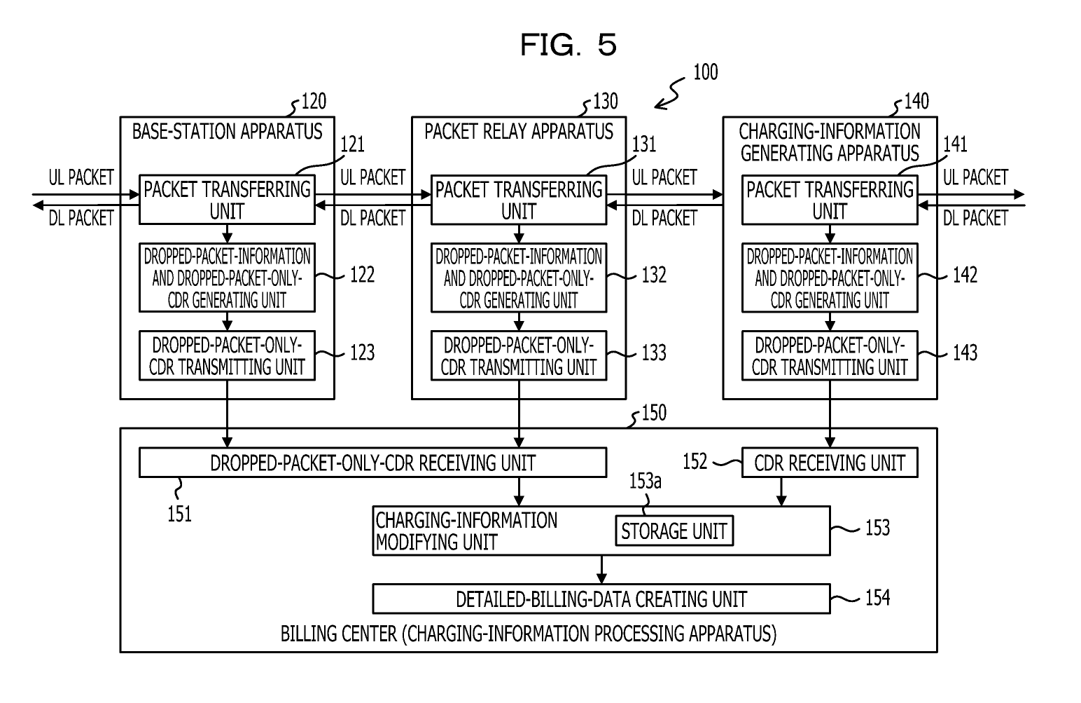

FIG. 5 illustrates an example of a configuration of the base-station apparatus 120, the packet relay apparatus 130, the charging-information generating apparatus 140, and the charging-information processing apparatus 150 in the charging system 100 that realizes the above-described charging-information modifying scheme.

As illustrated in FIG. 5, the base-station apparatus 120 includes a packet forwarding unit 121, a dropped-packet-information and dropped-packet-only-CDR generating unit (a “generating unit”) 122, and a dropped-packet-only-CDR transmitting unit (a “transmitting unit”) 123.

The packet forwarding unit 121 is an example of a first data forwarding unit or a data forwarding unit. The generating unit 122 is an example of a first generating unit or a generating unit. The transmitting unit 123 is an example of a first transmitting unit or a transmitting unit.

The packet forwarding unit 121 forwards DL packets and UL packets.

Based on the relevant session information, the generating unit 122 generates dropped-packet information, which is information regarding DL packets dropped at the packet forwarding unit 121 due to an internal factor of the base-station apparatus 120. The dropped-packet information is an example of non-forwardable-data information regarding terminal-apparatus-addressed data (that is, data addressed to the terminal apparatus 110) that is forwarded via at least the charging-information generating apparatus 140 and not forwarded by the packet forwarding unit 121. The generating unit 122 generates a dropped-packet-only CDR 120a for each bearer for DL packets dropped at the packet forwarding unit 121 due to an internal factor of the base-station apparatus 120. The generating unit 122 also records dropped-packet information for each bearer in the corresponding dropped-packet-only CDR 120a.

The transmitting unit 123 transmits, to the charging-information processing apparatus 150, each dropped-packet-only CDR 120a in which dropped-packet information is recorded by the generating unit 122.

Similarly, the packet relay apparatus 130 includes a packet forwarding unit 131, a dropped-packet-information and dropped-packet-only-CDR generating unit (a “generating unit”) 132, and a dropped-packet-only-CDR transmitting unit (a “transmitting unit”) 133.

The packet forwarding unit 131 is an example of a second data forwarding unit or a data forwarding unit. The generating unit 132 is an example of a second generating unit or a generating unit. The transmitting unit 133 is an example of a second transmitting unit or a transmitting unit.

The packet forwarding unit 131 forwards DL packets and UL packets.

Based on the relevant session information, the generating unit 132 generates dropped-packet information, which is information regarding DL packets dropped at the packet forwarding unit 131 due to an internal factor of the packet relay apparatus 130. The dropped-packet information is an example of non-forwardable-data information regarding terminal-apparatus-addressed data that is forwarded via at least the charging-information generating apparatus 140 and not forwarded by the packet forwarding unit 131. The generating unit 132 generates a dropped-packet-only CDR 130a for each bearer for DL packets dropped at the packet forwarding unit 131 due to an internal factor of the packet relay apparatus 130. The generating unit 132 also records the dropped-packet information for each bearer in the corresponding dropped-packet-only CDR 130a.

The transmitting unit 133 transmits, to the charging-information processing apparatus 150, each dropped-packet-only CDR 130a in which the dropped-packet information was recorded by the generating unit 132.

The charging-information generating apparatus 140 includes a packet forwarding unit 141, a passed-packet-charging-information and CDR generating unit (a “generating unit”) 142, and a CDR transmitting unit 143.

The packet forwarding unit 141 is an example of a third data forwarding unit. The generating unit 142 is an example of a charging-information generating unit. The CDR transmitting unit 143 is an example of a third transmitting unit.

The packet forwarding unit 141 forwards DL packets and UL packets.

The generating unit 142 generates charging information, which is information regarding packets that passed through the charging-information generating apparatus 140. The information regarding packets that passed through the charging-information generating apparatus 140 is also information based on packets forwarded by the packet forwarding unit 141. The generating unit 142 generates a CDR 140a for each bearer. The generating unit 142 records the charging information in the corresponding CDR 140a.

The CDR transmitting unit 143 transmits, to the charging-information processing apparatus 150, each CDR 140a to which charging information was recorded by the generating unit 142.

The charging-information processing apparatus 150 includes a dropped-packet-only-CDR receiving unit (a “receiving unit”) 151, a CDR receiving unit 152, a charging-information modifying unit 153, and a detailed-billing-data creating unit (a “creating unit”) 154.

The receiving unit 151 is an example of a second receiving unit. The CDR receiving unit 152 is an example of a first receiving unit.

The receiving unit 151 receives each dropped-packet-only CDR 120a transmitted from the base-station apparatus 120 and each dropped-packet-only CDR 130a transmitted from the packet relay apparatus 130.

The CDR receiving unit 152 receives each CDR 140a transmitted from the charging-information generating apparatus 140.

The charging-information modifying unit 153 includes a storage unit 153a in which the dropped-packet-only CDRs 120a and 130a received by the receiving unit 151 and each CDR 140a received by the CDR receiving unit 152 are stored. The charging-information modifying unit 153 modifies the charging information recorded in each CDR 140a, based on the dropped-packet information recorded in the corresponding dropped-packet-only CDRs 120a and 130a.

The creating unit 154 performs, for example, creation of detailed billing data for a corresponding subscriber (that is, the user of the terminal apparatus 110), based on the charging information modified by the charging-information modifying unit 153 or the charging information recorded in a CDR 140a.

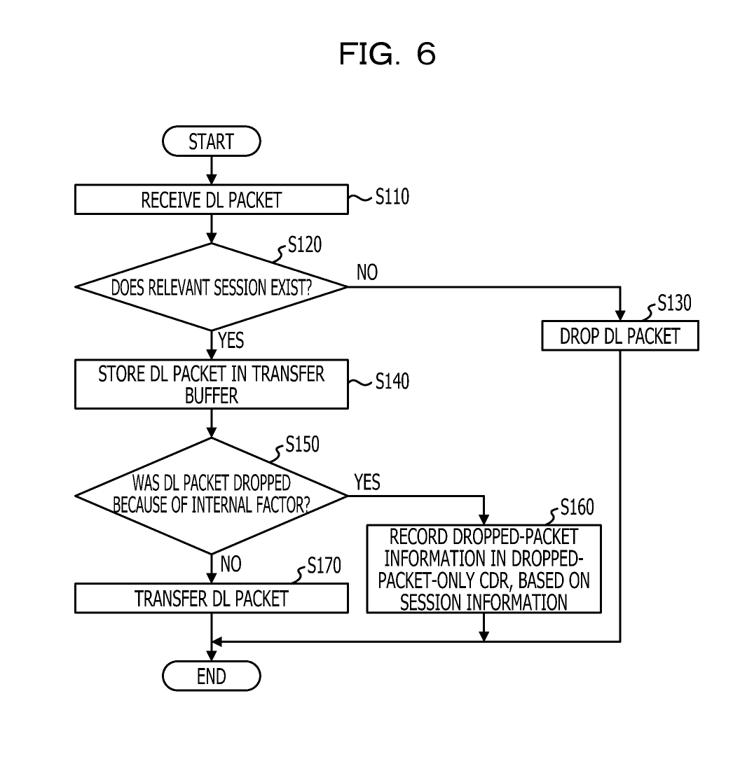

FIG. 6 is a flowchart illustrating an example of operations performed by the base-station apparatus 120 and the packet relay apparatus 130. Although an operation performed by the base-station apparatus 120 is described by way of example, the packet relay apparatus 130 also performs a same or similar operation.

As illustrated in FIG. 6, in step S110, the base-station apparatus 120 receives a DL packet forwarded from elsewhere. In response, in step S120, the packet forwarding unit 121 determines whether a session relevant to the DL packet exists. The presence/absence of a session is determined based on whether the session information managed by the base-station apparatus 120 contains session information related to the DL packet.

When a result of the determination in step S120 is No, the process proceeds to step S130 in which the packet forwarding unit 121 drops the DL packet received in step S110. Thereafter, the operations end.

However, when the result of the determination in step S120 is Yes, the process proceeds to step S140 in which the packet forwarding unit 121 stores, in a packet-forwarding buffer memory (not illustrated), the DL packet received in step S110. Subsequently, in step S150, the generating unit 122 determines whether the DL packet was dropped due to an internal factor of the base-station apparatus 120. An internal factor of the base-station apparatus 120 is, for example, overflow of the packet-forwarding buffer memory.

When a result of the determination in step S150 is Yes, the process proceeds to step S160 in which the generating unit 122 performs processing as follows. The generating unit 122 first generates a dropped-packet-only CDR 120a for the bearer for the dropped DL packet. However, when the dropped-packet-only CDR 120a is already generated, the generating unit 122 does not perform the generation. The generating unit 122 also generates dropped-packet information, which is information related to the dropped DL packet. The generating unit 122 also records the dropped-packet information in the corresponding dropped-packet-only CDR 120a. During the recording, for example, the data volume of the dropped DL packet is added to a dropped-DL-packet data volume recorded in the dropped-packet-only CDR 120a. When step S160 is finished, the operation ends.

However, when a result of the determination in step S150 is No, the process proceeds to step S170 in which the packet forwarding unit 121 forwards the DL packet stored in the packet-forwarding buffer memory in step S140. Thereafter, the operation ends.

Thereafter, the dropped-packet-only CDR 120a in which the dropped-packet information is recorded as described above is transmitted from the transmitting unit 123 to the charging-information processing apparatus 150, as appropriate. For example, each time the dropped-packet-only CDR 120a is closed, the dropped-packet-only CDR 120a may be transmitted. Alternatively, for example, one or more closed dropped-packet-only CDRs 120a are transmitted at given intervals.

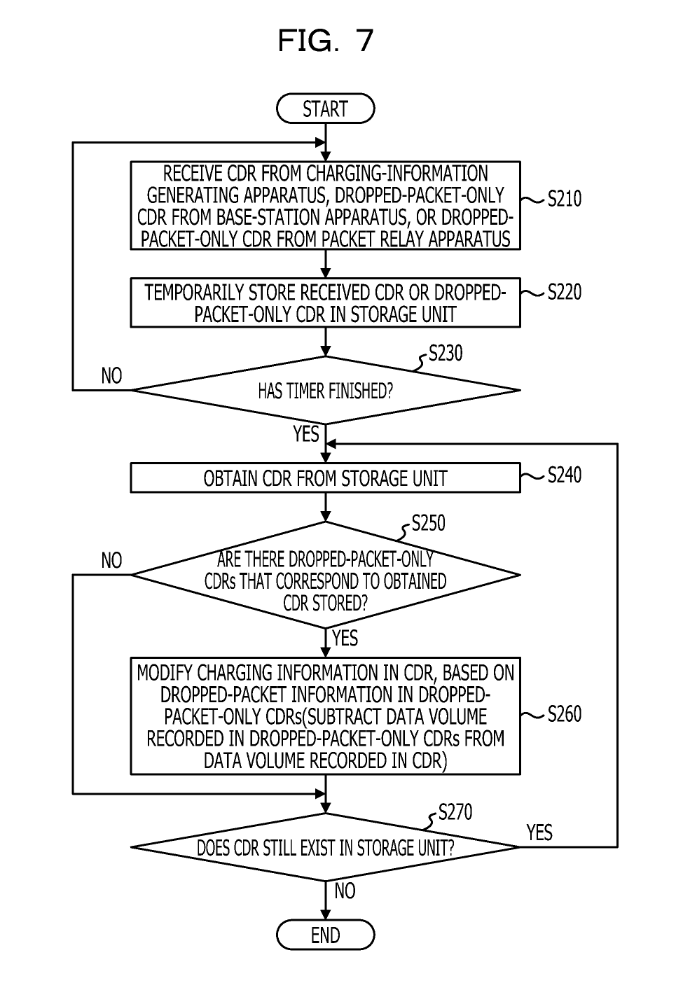

FIG. 7 is a flowchart illustrating an example of an operation performed by the charging-information processing apparatus 150.

As illustrated in FIG. 7, in step S210, the CDR receiving unit 152 in the charging-information processing apparatus 150 receives a CDR 140a or the receiving unit 151 receives a dropped-packet-only CDR 120a or 130a. In response, in step S220, the charging-information processing apparatus 150 temporarily stores the CDR 140a or the dropped-packet-only CDR 120a or 130a in the storage unit 153a. The CDR 140a is transmitted from the charging-information generating apparatus 140. The dropped-packet-only CDR 120a is transmitted from the base-station apparatus 120. The dropped-packet-only CDR 130a is transmitted from the packet relay apparatus 130. The charging-information processing apparatus 150 further has a timer. When the reception in step S210 is performed, the charging-information processing apparatus 150 starts the timer for which a given amount of time is set. However, when the timer has already been started, the charging-information processing apparatus 150 does not start the timer. The given time set for the timer is, for example, a desirable amount of time for all of the CDR 140a and the dropped-packet-only CDRs 120a and 130a for the same bearer to be stored in the storage unit 153a.

In step S230 subsequent to step S220, the charging-information modifying unit 153 determines whether the timer has expired. When the result of the determination in step S230 is No, the process returns to step S210.

However, when the result of the determination in step S230 is Yes, the process proceeds to step S240 in which the charging-information modifying unit 153 obtains, from the storage unit 153a, a CDR 140a that has not yet been set as a processing target. In step S250, the charging-information modifying unit 153 determines whether a dropped-packet-only CDR 120a or dropped-packet-only CDR 130a corresponding to the CDR 140a obtained in step S240 is stored in the storage unit 153a. The dropped-packet-only CDR 120a or 130a corresponding to the CDR 140a obtained in step S240 refer to, for example, dropped-packet-only CDRs 120a and 130a that have the same subscriber identifier and have the same (or substantially the same) charging-recording start time. When the result of the determination in step S250 is Yes, the generating unit 153 performs processing as described below. That is, in step S260, the charging-information modifying unit 153 modifies the charging information recorded in the CDR 140a obtained in step S240, based on the dropped-packet information recorded in the dropped-packet-only CDR 120a or 130a that corresponds to the CDR 140a. In the modification, for example, the data volume of the dropped DL packet, the data volume being contained in the dropped-packet information, is subtracted from the downlink-pass data volume contained in the charging information. When step S260 is finished or when the result of the determination in step S250 is No, the process proceeds to step S270 in which the charging-information modifying unit 153 determines whether any CDR 140a that has not been set as a processing target is stored in the storage unit 153a. When a result of the determination in step S270 is Yes, the process returns to step S240, and when the result of the determination in step S270 is No, the operation ends.

Thereafter, the detailed-billing-data creating unit 154 uses the CDR 140a in which the charging information was modified as described above or the CDR 140a in which the charging information was not modified, to perform, for example, creation of detailed billing data for the corresponding subscriber.

As described above, in the charging system 100 according to the present embodiment, when a DL packet that passed through the charging-information generating apparatus 140 is dropped at the base-station apparatus 120 or packet relay apparatus 130 due to an internal factor thereof, the charging information recorded in the CDR 140a is modified. For example, the data volume of the DL packet dropped at the base-station apparatus 120 or the packet relay apparatus 130 due to the internal factor thereof is subtracted from the downlink-pass data volume contained in the charging information. This arrangement, therefore, suppresses charging for a DL packet dropped at either the base-station apparatus 120 or the packet relay apparatus 130 due to an internal factor thereof.

The charging system 100 according to the present embodiment may be modified as described below.

For example, the charging system 100 according to the present embodiment is configured so that bearer-level charging control is performed, but may also be configured so that service-flow-level charging control is performed. However, in such a case, the charging system 100 is configured so that PCC reported to the charging-information generating apparatus 140 is also reported to the base-station apparatus 120 and the packet relay apparatus 130. The base-station apparatus 120 and the packet relay apparatus 130 are also configured so that the corresponding dropped-packet-only CDRs in which the dropped-packet information is recorded and which correspond to the reported PCC are transmitted to the charging-information processing apparatus 150.

The charging system 100 according to the present embodiment may also be applied to, for example, a communications network defined by 3GPP, which is described below.

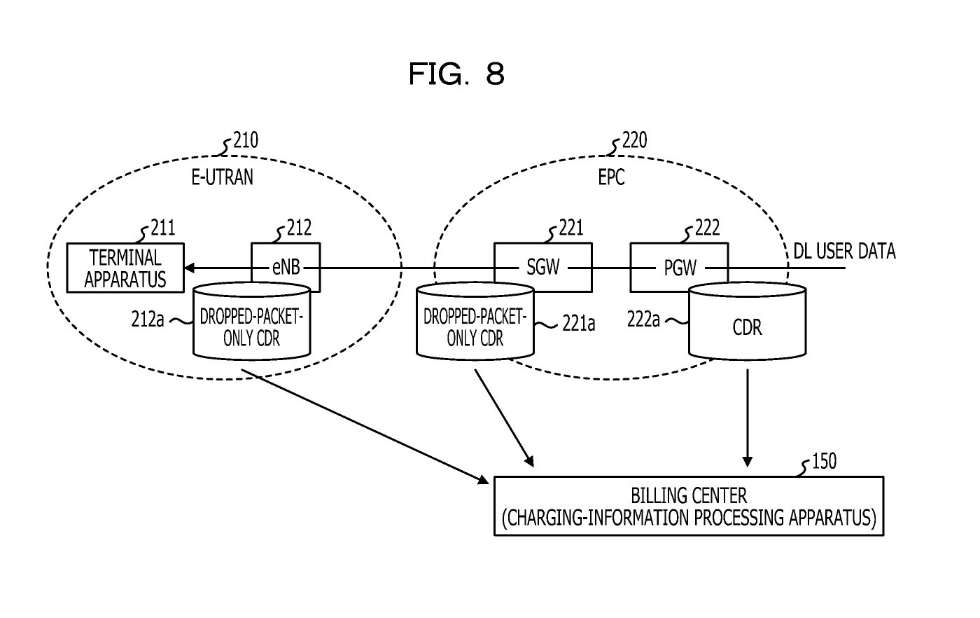

FIG. 8 illustrates an example in which the charging system 100 according to the present embodiment is applied to a communications network that includes an evolved universal terrestrial radio access network (E-UTRAN) and an evolved packet core (EPC) network. This communications network is also a communications network that includes an EPC network when an E-UTRAN is used as a wireless access network.

In the communications network illustrated in FIG. 8, in an E-UTRAN 210, a terminal apparatus 211 corresponds to the above-described terminal apparatus 110. Furthermore, an evolved node B (eNB) 212 includes the function of the above-described base-station apparatus 120 and a dropped-packet-only CDR 212a corresponds to the above-described dropped-packet-only CDR 120a. In an EPC 220, a serving gateway (SGW) 221 includes the function of the above-described packet relay apparatus 130 and a dropped-packet-only CDR 221a corresponds to the above-described dropped-packet-only CDR 130a. A packet data network gateway (PGW) 222 includes the function of the above-described charging-information generating apparatus 140 and a CDR 222a corresponds to the above-described CDR 140a.

In the communications network illustrated in FIG. 8, the charging-information processing apparatus 150 receives the dropped-packet-only CDR 212a transmitted from the eNB 212, the dropped-packet-only CDR 221a transmitted from the SGW 221, and the CDR 222a transmitted from the PGW 222. The charging-information processing apparatus 150 modifies the charging information recorded in the CDR 222a, based on the dropped-packet information recorded in one or both of the dropped-packet-only CDRs 221a and 222a.

This arrangement inhibits charging for a DL packet dropped due to an internal factor of the eNB 212 or the SGW 221 in the communications network illustrated in FIG. 8.

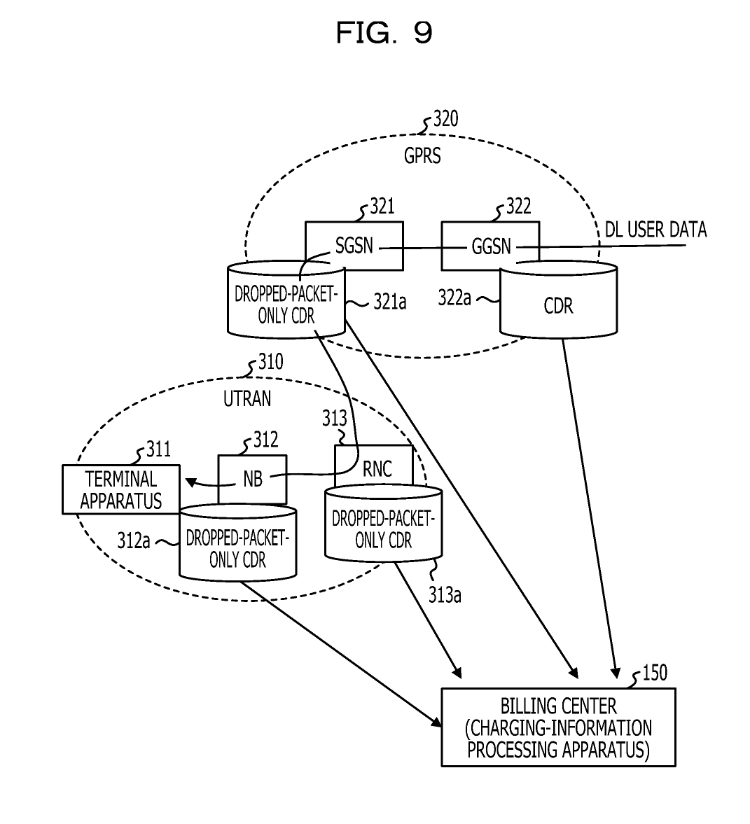

FIG. 9 illustrates an example in which the charging system 100 according to the present embodiment is applied to a communications network that includes a universal terrestrial radio access network (UTRAN) and a general packet radio service (GPRS) network. This communications network is also a communications network that includes a GPRS network when a UTRAN is used as a wireless access network.

In the communications network illustrated in FIG. 9, in a UTRAN 310, a terminal apparatus 311 corresponds to the above-described terminal apparatus 110. Furthermore, a node B (NB) 312 includes the function of the above-described base-station apparatus 120 and a dropped-packet-only CDR 312a corresponds to the above-described dropped-packet-only CDR 120a. A radio network controller (RNC) 313 includes the function of the above-described packet relay apparatus 130 and a dropped-packet-only CDR 313a corresponds to the above-described dropped-packet-only CDR 130a. In a GPRS 320, a serving GPRS support node (SGSN) 321 includes the function of the above-described packet relay apparatus 130 and a dropped-packet-only CDR 321a corresponds to the above-described dropped-packet-only CDR 130a. A gateway GPRS support node (GGSN) 322 includes the function of the above-described charging-information generating apparatus 140 and a CDR 322a corresponds to the above-described CDR 140a.

In the communications network illustrated in FIG. 9, the charging-information processing apparatus 150 receives the dropped-packet-only CDR 312a transmitted from the NB 312, the dropped-packet-only CDR 313a transmitted from the RNC 313, and the dropped-packet-only CDR 321a transmitted from the SGSN 321. The charging-information processing apparatus 150 also receives the CDR 322a transmitted from a GGSN 322. The charging-information processing apparatus 150 modifies the charging information recorded in the CDR 322a, based on the dropped-packet information recorded in one or more of the dropped-packet-only CDRs 312a, 313a, and 321a.

As a result, with the communications network illustrated in FIG. 9, charging may be suppressed for a DL packet dropped due to an internal factor of the NB 312, the RNC 313, or the SGSN 321.

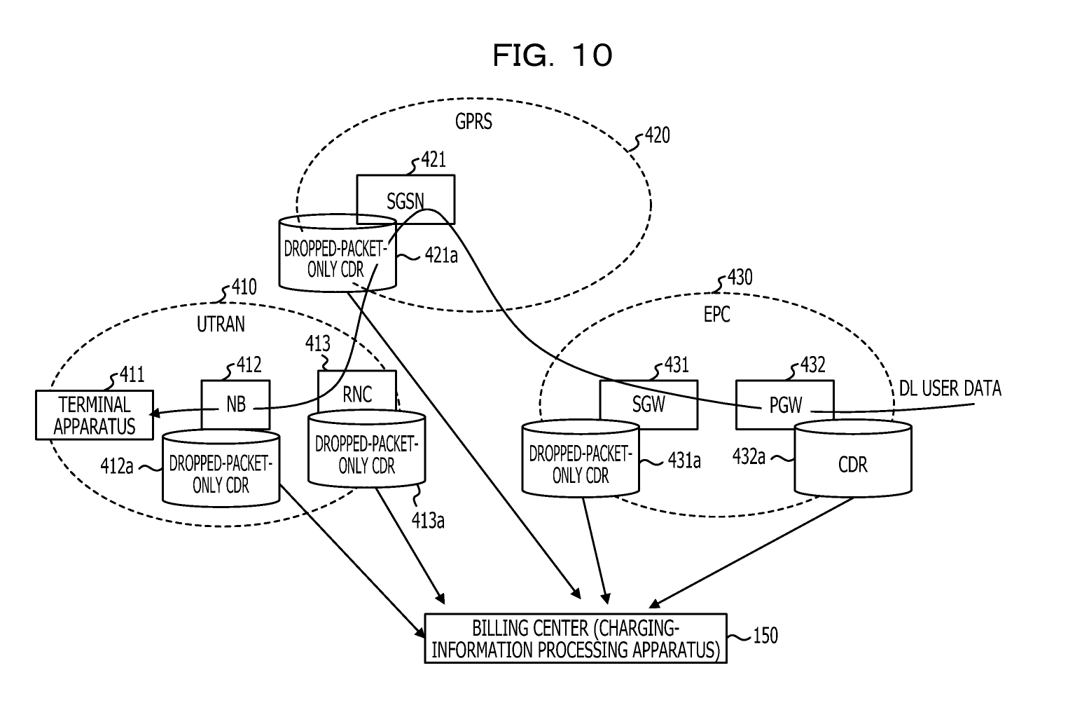

FIG. 10 illustrates an example in which the charging system 100 according to the present embodiment is applied to a communications network that includes a UTRAN, a GPRS network, and an EPC network. This communications network is also a communications network that includes an EPC network when a UTRAN is used as a wireless access network.

In the communications network illustrated in FIG. 10, in a UTRAN 410, a terminal apparatus 411 corresponds to the above-described terminal apparatus 110. Furthermore, an NB 412 includes the function of the above-described base-station apparatus 120, and a dropped-packet-only CDR 412a corresponds to the above-described dropped-packet-only CDR 120a. An RNC 413 includes the function of the above-described packet relay apparatus 130 and a dropped-packet-only CDR 413a corresponds to the above-described dropped-packet-only CDR 130a. In a GPRS 420, an SGSN 421 includes the function of the above-described packet relay apparatus 130 and a dropped-packet-only CDR 421a corresponds to the above-described dropped-packet-only CDR 130a. In an EPC 430, an SGW 431 includes the function of the above-described packet relay apparatus 130 and a dropped-packet-only CDR 431a corresponds to the above-described dropped-packet-only CDR 130a. A PGW 432 includes the function of the above-described charging-information generating apparatus 140 and a CDR 432a corresponds to the above-described CDR 140a.

In the communications network illustrated in FIG. 10, the charging-information processing apparatus 150 receives a dropped-packet-only CDR 412a transmitted from the NB 412, a dropped-packet-only CDR 413a transmitted from the RNC 413, and a dropped-packet-only CDR 421a transmitted from the SGSN 421. The charging-information processing apparatus 150 also receives a dropped-packet-only CDR 431a transmitted from the SGW 431 and a CDR 432a transmitted from the PGW 432. The charging-information processing apparatus 150 modifies the charging information recorded in the CDR 432a, based on the dropped-packet information recorded in one or more of the dropped-packet-only CDRs 412a, 413a, 421a, and 431a.

As a result, charging may be suppressed for a DL packet that is dropped due to an internal factor of the NB 412, the RNC 413, the SGSN 421, or the SGW 431 in the communications network illustrated in FIG. 10.

As the scheme for modifying the charging information by using CDRs, other than the scheme for the charging system 100 according to the present embodiment, a method such as the following is also conceivable. For example, the scheme may be implemented by a method in which the CDRs for DL packets are generated by each base-station apparatus instead of the charging-information generating apparatus.

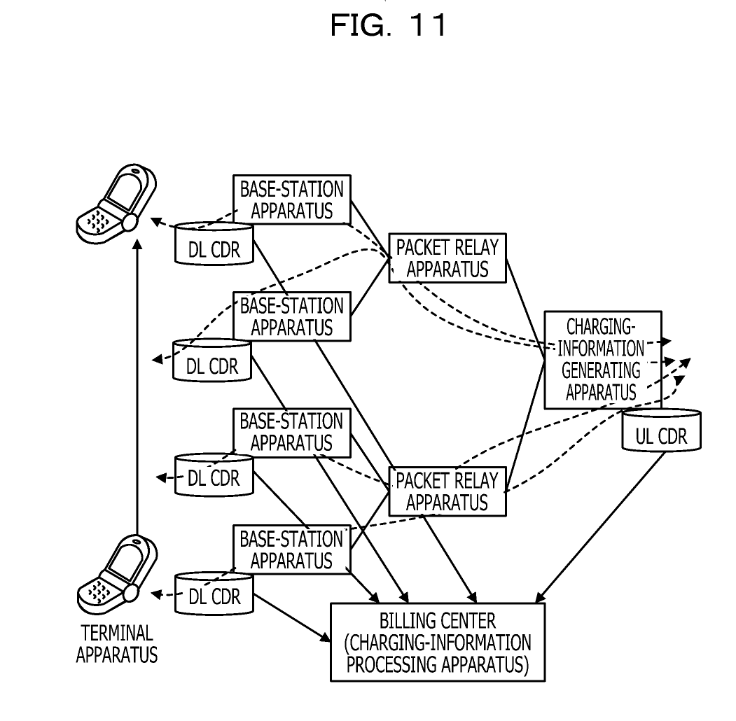

FIG. 11 illustrates an example of a charging system employing the method in which CDRs for DL packets are generated by each base-station apparatus.

As illustrated in FIG. 11, in this charging system, CDRs are generated separately for the downlink and the uplink, for example, a CDR for downlink (DL CDR) and a CDR for uplink (UL CDR) are generated. In this charging system, since a DL CDR is generated for each base-station apparatus, the number of CDRs generated increases each time the terminal apparatus (for example, a mobile phone) that is communicating moves and the base-station apparatus used is switched. Thus, in this charging system, the number of CDRs may increase considerably. Thus, there is a drawback in that, in the charging-information processing apparatus at the billing center, the capacity of a storage unit to temporarily store the received CDRs may be exceeded.

In contrast, in the charging system 100 according to the present embodiment, the dropped-packet-only CDRs 120a and 130a are generated for each bearer for a DL packet dropped at the base-station apparatus 120 and the packet relay apparatus 130. Thus, the dropped-packet-only CDRs 120a and 130a are not generated for a bearer from which no DL packet was dropped. Thus, since the number of dropped-packet-only CDRs generated may be sufficiently smaller than the number of DL CDRs generated for DL packets by the above-described method, the above-described drawback may not occur.

### Second Embodiment

The charging-information modifying scheme in the charging system according to a second embodiment is different from the scheme for the charging system according to the first embodiment. In the charging system according to the second embodiment, the charging information is modified when a DL packet is dropped due to an internal factor of at least the packet-relay apparatus or the base-station apparatus or when a DL packet is dropped since no relevant session exists due to an inter-apparatus-state mismatch.

In a description of the present embodiment, a charging system, a terminal apparatus, a base-station apparatus, a packet relay apparatus, a charging-information generating apparatus, and a charging-information processing apparatus at a billing center are denoted by reference numbers 500, 510, 520, 530, 540, and 550, respectively.

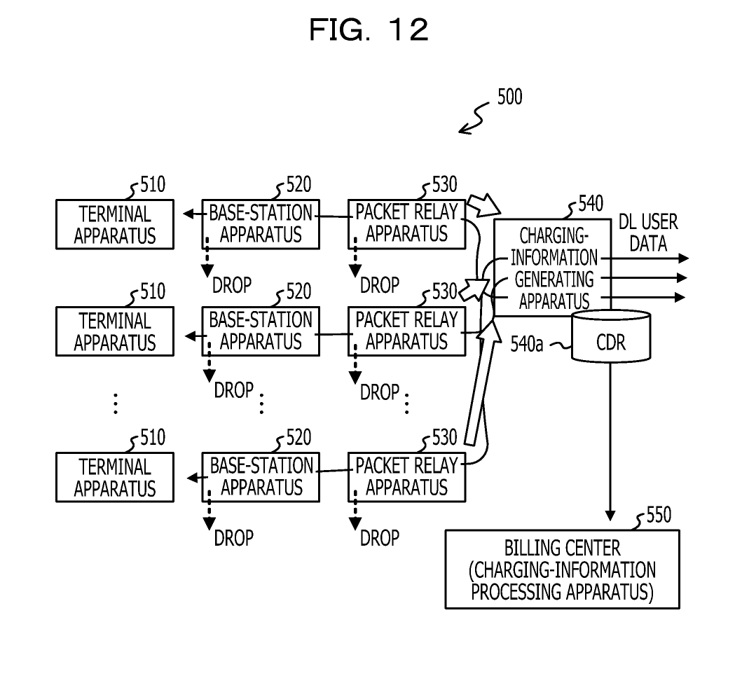

FIG. 12 illustrates an example of a scheme, in the charging system 500 according to the present embodiment, for modifying the charging information.

As illustrated in FIG. 12, each base-station apparatus 520 is adapted to transmit dropped-packet information, which is information regarding a DL packet dropped at the base-station apparatus 520, to a forward-source apparatus of the dropped DL packet. The dropped-packet information is an example of non-forwardable-data information. The dropped-packet information contains packet-drop time that represents the time when the DL packet was dropped as well as information about the data volume of the dropped DL packet. For example, when the dropped DL packet is a DL packet that was forwarded from the packet relay apparatus 530, the forward-source apparatus of the dropped DL packet is the packet relay apparatus 530.

The packet relay apparatus 530 is adapted to transmit dropped-packet information, which is information regarding DL packets dropped at the packet relay apparatus 530, to the forward-source apparatus of the dropped DL packet. The dropped-packet information is an example of non-forwardable-data information. The dropped-packet information contains packet-drop time that represents when the DL packet was dropped as well as information about the data volume of the dropped DL packet. For example, when a dropped DL packet has been forwarded from the charging-information generating apparatus 540, the forward-source apparatus of the dropped DL packet is the charging-information generating apparatus 540. The packet relay apparatus 530 may be adapted to transmit dropped-packet information, obtained by merging the dropped-packet information and the dropped-packet information transmitted from the forward-destination apparatus of the forwarded DL packet, to the forward-source apparatus of the DL packet. For example, when the forwarded DL packet is forwarded to the base-station apparatus 520, the forward-destination apparatus of the forwarded DL packet is the base-station apparatus 520. The packet relay apparatus 530 may also be adapted to transmit the dropped-packet information, transmitted from the forward-destination apparatus of the forwarded DL packet, to the forward-source apparatus of the DL packet.

In FIG. 12, arrows from the base-station apparatuses 520 to the packet relay apparatuses 530 and arrows from the packet relay apparatuses 530 to the charging-information generating apparatus 540 indicate flows of the dropped-packet information.

The charging-information generating apparatus 540 is adapted to modify the charging information based on the dropped-packet information transmitted from the forward-destination apparatus of the forwarded DL packet. For example, when the forwarded DL packet is forwarded to the packet relay apparatus 530, the forward-destination apparatus of the forwarded DL packet is the packet relay apparatus 530. For example, the charging-information generating apparatus 540 is adapted to transmit, to the charging-information processing apparatus 550, a CDR 540a in which the modified charging information is recorded.

The charging-information processing apparatus 550 performs, for example, creation of detailed billing data for a corresponding subscriber (that is, a user of the terminal apparatus 510), based on the charging information recorded in the CDR 540a transmitted from the charging-information generating apparatus 540.

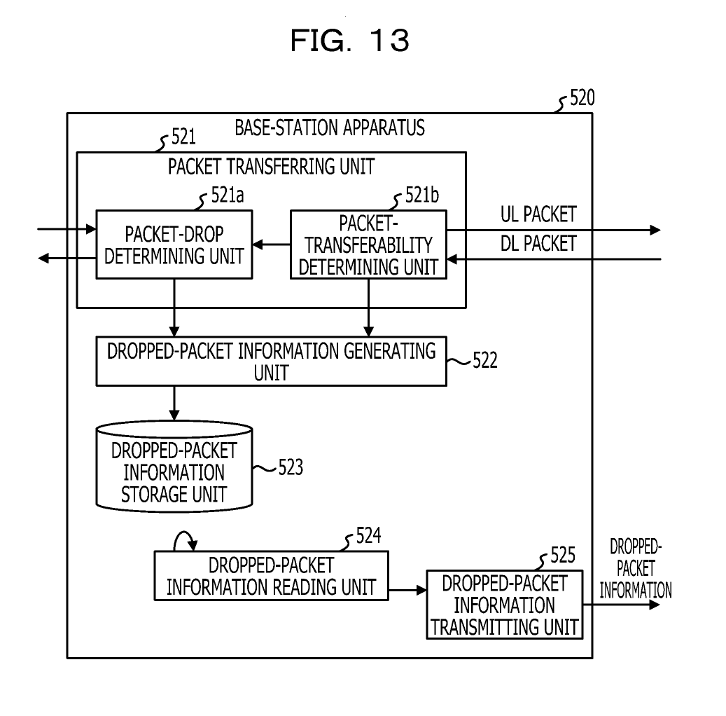

FIG. 13 illustrates an example of a configuration of the base-station apparatus 520.

As illustrated in FIG. 13, the base-station apparatus 520 includes a packet forwarding unit 521, a dropped-packet information generating unit 522, a dropped-packet information storage unit 523, a dropped-packet information reading unit 524, and a dropped-packet information transmitting unit 525.

The packet forwarding unit 521 is an example of a first data forwarding unit or a data forwarding unit. The dropped-packet information generating unit 522 is an example of a first generating unit or a generating unit. The dropped-packet information transmitting unit 525 is an example of a first transmitting unit or a transmitting unit.

The packet forwarding unit 521 forwards DL packets and UL packets. The packet forwarding unit 521 includes a packet-drop determining unit 521a and a packet-forwardability determining unit 521b. The packet-drop determining unit 521a determines whether a DL packet to be transmitted (or, to be forwarded) was dropped due to an internal factor of the base-station apparatus 520. The packet-forwardability determining unit 521b determines whether a received DL packet (a forwarded DL packet) is forwardable. Whether the received DL packet is forwardable is determined based on the presence/absence of a session relevant to the DL packet. When the received DL packet is not forwardable, the DL packet is dropped.

When a DL packet is dropped, based on results of the determinations made by the packet-drop determining unit 521a and the packet-forwardability determining unit 521b, the dropped-packet information generating unit 522 generates dropped-packet information and stores the dropped-packet information in the dropped-packet information storage unit 523. For example, when the packet-drop determining unit 521a determines that a DL packet to be transmitted is dropped, the dropped-packet information generating unit 522 generates information about the dropped DL packet as dropped-packet information and stores the dropped-packet information in the dropped-packet information storage unit 523. For example, when the packet-forwardability determining unit 521b determines that a received DL packet is not forwardable, the dropped-packet information generating unit 522 generates information about the DL packet as dropped-packet information and stores the dropped-packet information in the dropped-packet information storage unit 523. The dropped-packet information generated by the dropped-packet information generating unit 522 is an example of non-forwardable-data information regarding terminal-apparatus-addressed data that is forwarded via at least the charging-information generating apparatus 540 and not forwarded by the packet forwarding unit 521.

The dropped-packet information reading unit 524 reads the dropped-packet information from the dropped-packet information storage unit 523.

The dropped-packet information transmitting unit 525 transmits the dropped-packet information, read by the dropped-packet information reading unit 524, to the forward-source apparatus of the non-forwardable DL packet relevant to the dropped-packet information.

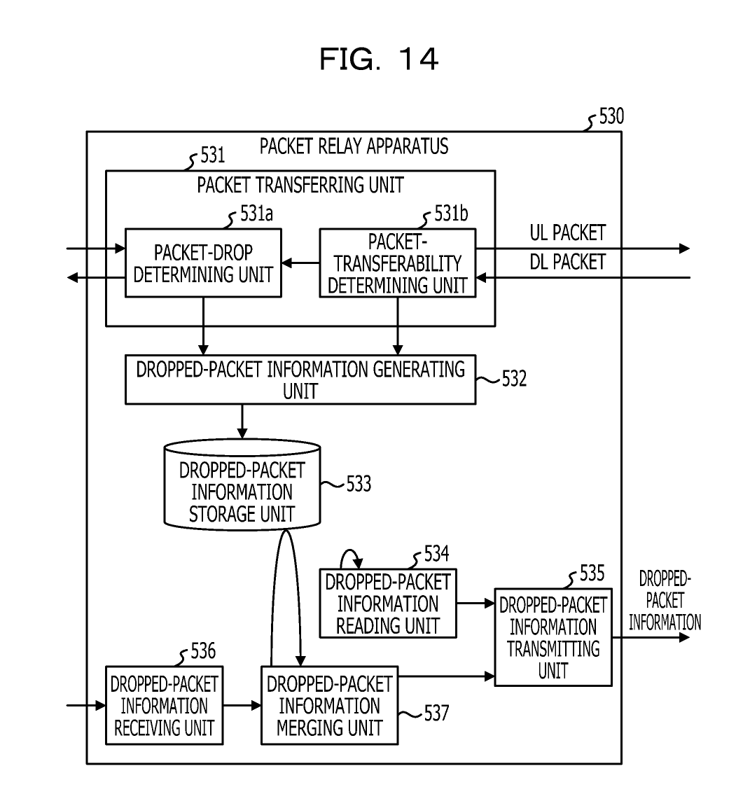

FIG. 14 illustrates an example of a configuration of the packet relay apparatus 530.

As illustrated in FIG. 14, the packet relay apparatus 530 includes a packet forwarding unit 531, a dropped-packet information generating unit 532, a dropped-packet information storage unit 533, a dropped-packet information reading unit 534, and a dropped-packet information transmitting unit 535. The packet relay apparatus 530 further includes a dropped-packet information receiving unit 536 and a dropped-packet information merging unit 537.

The packet forwarding unit 531 is an example of a second data forwarding unit or a data forwarding unit. The dropped-packet information generating unit 532 is an example of a second generating unit or a generating unit. The dropped-packet information transmitting unit 535 is an example of a second transmitting unit or a transmitting unit. The dropped-packet information receiving unit 536 is an example of a first receiving unit or a receiving unit. The dropped-packet information merging unit 537 is an example of a merging unit.

The packet forwarding unit 531 forwards DL packets and UL packets. The packet forwarding unit 531 includes a packet-drop determining unit 531a and a packet-forwardability determining unit 531b. The packet-drop determining unit 531a determines whether a DL packet to be transmitted (or, to be forwarded) was dropped due to an internal factor of the packet relay apparatus 530. The packet-forwardability determining unit 531b determines whether a received DL packet (a forwarded DL packet) is forwardable. The determination as to whether a received DL packet is forwardable is made based on the presence/absence of a session relevant to the DL packet. When the received DL packet is not forwardable, the DL packet is dropped.

When a DL packet is dropped, based on results of the determinations made by the packet-drop determining unit 531a and the packet-forwardability determining unit 531b, the dropped-packet information generating unit 532 generates dropped-packet information and stores the dropped-packet information in the dropped-packet information storage unit 533. For example, when the packet-drop determining unit 531a determines that a DL packet to be transmitted was dropped, the dropped-packet information generating unit 532 generates information about the dropped DL packet as dropped-packet information and stores the dropped-packet information in the dropped-packet information storage unit 533. For example, when the packet-forwardability determining unit 531b determines that a received DL packet is not forwardable, the dropped-packet information generating unit 532 generates information about the DL packet as dropped-packet information and stores the dropped-packet information in the dropped-packet information storage unit 533. The dropped-packet information generated by the dropped-packet information generating unit 532 is an example of non-forwardable-data information regarding terminal-apparatus-addressed data that is forwarded via at least the charging-information generating apparatus 540 and not forwarded by the packet forwarding unit 531.

The dropped-packet information reading unit 534 reads dropped-packet information from the dropped-packet information storage unit 533.

The dropped-packet information receiving unit 536 receives dropped-packet information transmitted from the forward-destination apparatus of a DL packet forwarded by the packet forwarding unit 531.

The dropped-packet information merging unit 537 merges the dropped-packet information received by the dropped-packet information receiving unit 536 and the corresponding dropped-packet information stored in the dropped-packet information storage unit 533. The corresponding dropped-packet information is dropped-packet information regarding the non-forwardable DL packet for the same bearer as the bearer for the non-forwardable DL packet relevant to the dropped-packet information received by the dropped-packet information receiving unit 536.

The dropped-packet information transmitting unit 525 transmits the dropped-packet information, read by the dropped-packet information reading unit 524, to the forward-source apparatus of the non-forwardable DL packet relevant to the dropped-packet information. Alternatively, the dropped-packet information transmitting unit 525 transmits the dropped-packet information, merged by the dropped-packet information merging unit 537, to the forward-source apparatus of the non-forwardable DL packet relevant to the dropped-packet information. The dropped-packet information transmitting unit 525 may also transmit the dropped-packet information, as received by the dropped-packet information receiving unit 536 and without being altered by a merge, to the forward-source apparatus of the non-forwardable DL packet relevant to the dropped-packet information.

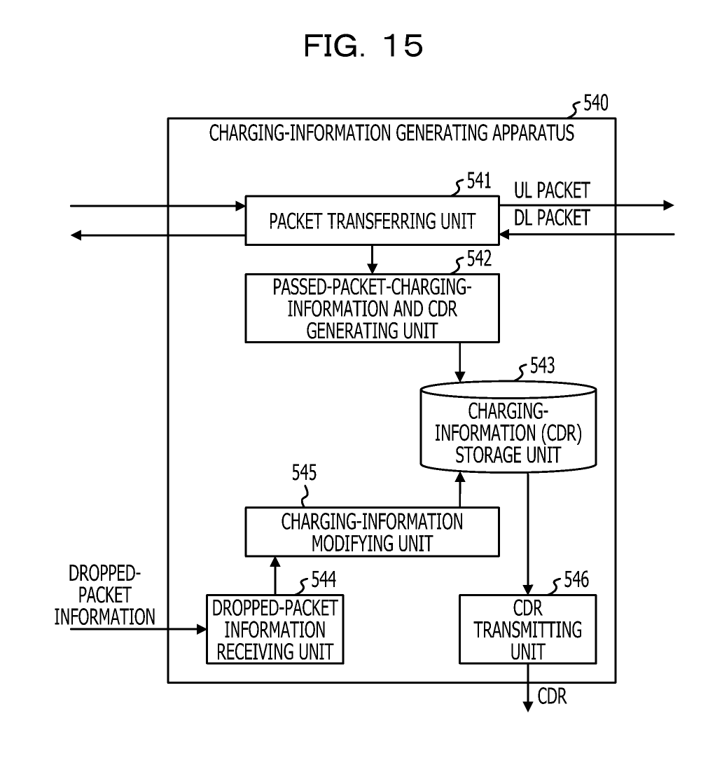

FIG. 15 illustrates an example of a configuration of the charging-information generating apparatus 540.

The charging-information generating apparatus 540 includes a packet forwarding unit 541, a passed-packet-charging-information and CDR generating unit (a “generating unit”) 542, a charging-information storage unit 543, a dropped-packet information receiving unit 544, a charging-information modifying unit 545, and a CDR transmitting unit 546.

The packet forwarding unit 541 is an example of a third data forwarding unit or a data forwarding unit. The generating unit 542 is an example of a charging-information generating unit. The dropped-packet information receiving unit 544 is an example of a second receiving unit or a receiving unit. The CDR transmitting unit 546 is an example of a transmitting unit.

The packet forwarding unit 541 forwards DL packets and UL packets.

The generating unit 542 generates a CDR 540a for each bearer and stores the CDR 540a in the charging-information storage unit 543. The generating unit 542 generates charging information for a packet that passed through the charging-information generating apparatus 540 and records the charging information in the corresponding CDR 540a stored in the charging-information storage unit 543. In the recording, for example, the data volume of the DL packet that passed through the charging-information generating apparatus 540 is added to the downlink-pass data volume contained in the charging information recorded in the corresponding CDR 540a. The information regarding the packet that passed through the charging-information generating apparatus 540 is also information based on the packet forwarded by the packet forwarding unit 541.

The dropped-packet information receiving unit 544 receives the dropped-packet information transmitted from the forward-destination apparatus of a DL packet forwarded by the packet forwarding unit 541.

Based on the dropped-packet information received by the dropped-packet information receiving unit 544, the charging-information modifying unit 545 modifies the charging information recorded in the corresponding CDR 540a stored in the charging-information storage unit 543. The corresponding CDR 540a refers to a CDR 540a for the bearer for the non-forwardable DL packet relevant to the dropped-packet information. The corresponding CDR 540a also contains, in the recording period of the charging information recorded in the CDR 540a, the packet-drop time contained in the drop-packet information. Whether the packet-drop time contained in the dropped-packet information is included in the period of recording for the charging information recorded in the CDR 540a may be determined based on information regarding the charging-recording start time, the charging-recording period, and so on that is contained in the charging information.

The CDR transmitting unit 546 transmits the CDR 540a, stored in the charging-information storage unit 543, to the charging-information processing apparatus 550. For example, the CDR transmitting unit 546 transmits the CDR 540a in which charging information modified by the charging-information modifying unit 545 is recorded and the CDR 540a in which charging information not modified by the charging-information modifying unit 545 is recorded.

The charging-information processing apparatus 550 performs, for example, creation of detailed billing data for the corresponding subscriber (that is, the user of the terminal apparatus 510), based on the charging information recorded in the CDR 540a transmitted from the charging-information generating apparatus 540.

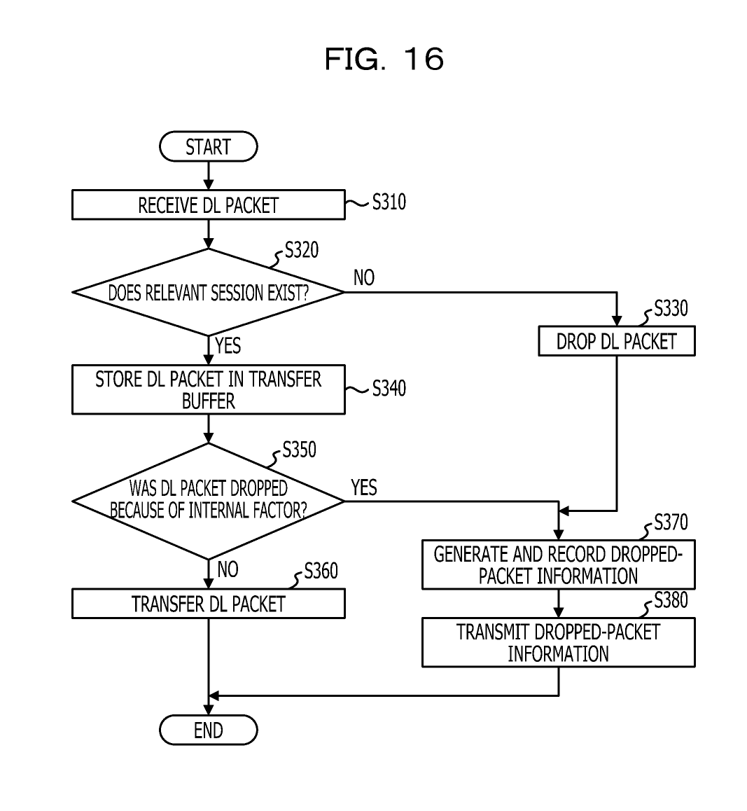

FIG. 16 is a flowchart illustrating an example of an operation performed by the base-station apparatus 520.

As illustrated in FIG. 16, in step S310, the base-station apparatus 520 receives a DL packet forwarded from elsewhere. In response, in step S320, the packet-forwardability determining unit 521b in the packet forwarding unit 521 determines whether a session relevant to the DL packet exists. The presence/absence of the session is determined based on whether the session information managed by the base-station apparatus 520 contains session information related to the DL packet.

When the result of the determination in step S320 is No, the process proceeds to step S330 in which the packet forwarding unit 521 drops the DL packet received in step S310. Thereafter, the process proceeds to step S370.

However, when the result of the determination in step S320 is Yes, the process proceeds to step S340 in which the packet forwarding unit 521 stores, in a packet-forwarding buffer memory (not illustrated), the DL packet received in step S310. Subsequently, in step S350, the packet-drop determining unit 521a in the packet forwarding unit 521 determines whether the DL packet was dropped due to an internal factor of the base-station apparatus 520. An internal factor of the base-station apparatus 520 is, for example, overflow of the packet-forwarding buffer memory.

However, when the result of the determination in step S350 is No, the process proceeds to step S360 in which the packet forwarding unit 521 forwards the DL packet stored in the packet-forwarding buffer memory in step S340. Thereafter, the operation ends.

When the result of the determination in step S350 is Yes or the processing in step S330 is finished, the process proceeds to step S370 in which the generating unit 522 generates dropped-packet information, which is information about the dropped DL packet, and stores the dropped-packet information in the dropped-packet information storage unit 523. The generated dropped-packet information contains information about the time when the DL packet was dropped and information about the data volume of the dropped DL packet. The dropped-packet information reading unit 524 reads the dropped-packet information from the dropped-packet information storage unit 523. In step S380, the dropped-packet information transmitting unit 525 transmits the dropped-packet information to the forward-source apparatus of the non-forwardable DL packet relevant to the dropped-packet information. Thereafter, the operation ends.

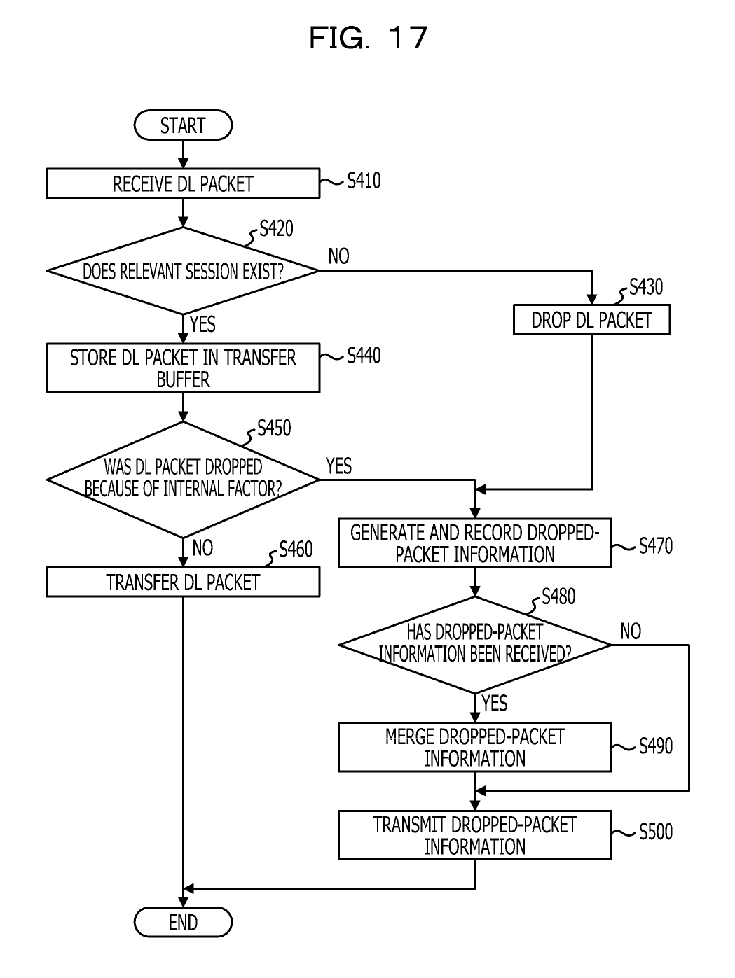

FIG. 17 is a flowchart illustrating an example of an operation performed by the packet relay apparatus 530.

As illustrated in FIG. 17, steps S410 to S460 performed by the packet relay apparatus 530 are analogous to steps S310 to S360 illustrated in FIG. 16. When a result of the determination in step S450 is Yes or the processing in step S430 is finished, the process proceeds to step S470 in which the generating unit 532 generates dropped-packet information, which is information about the dropped DL packet, and stores the dropped-packet information in the dropped-packet information storage unit 533. The generated dropped-packet information contains information about the time when the DL packet was dropped and information about the data volume of the dropped DL packet. In step S480, the dropped-packet information merging unit 537 determines whether there is dropped-packet information that is to be merged. This determination is made by determining whether there is dropped-packet information corresponding to the dropped-packet information received by the dropped-packet information receiving unit 536 in the dropped-packet information storage unit 533. When the result of the determination in step S480 is Yes, the process proceeds to step S490 in which the dropped-packet information merging unit 537 merges the dropped-packet information received by the dropped-packet information receiving unit 536 and the corresponding dropped-packet information stored in the dropped-packet information storage unit 533. In step S500, the dropped-packet information transmitting unit 535 transmits the dropped-packet information, merged in step S490, to the forward-source apparatus of the non-forwardable DL packet relevant to the dropped-packet information. Thereafter, the operation ends.

However, when the result of the determination in step S480 is No, the process proceeds to step S500 in which the dropped-packet information transmitting unit 535 transmits the dropped-packet information, stored in the dropped-packet information storage unit 533 in step S470, to the forward-source apparatus of the non-forwardable DL packet relevant to the dropped-packet information. Thereafter, the operation ends.

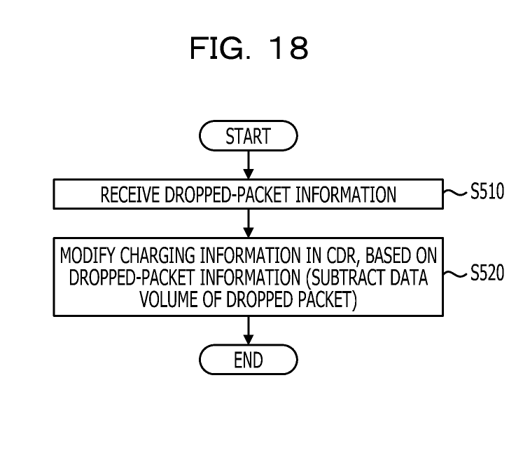

FIG. 18 is a flowchart illustrating an example of an operation performed by the charging-information generating apparatus 540.

As illustrated in FIG. 18, in step S510, the dropped-packet information receiving unit 544 in the charging-information generating apparatus 540 receives dropped-packet information transmitted from the forward-destination apparatus of a DL packet forwarded by the packet forwarding unit 541. In response, the charging-information generating apparatus 540 performs processing as described below. In step S520, based on the dropped-packet information received by the dropped-packet information receiving unit 544 in step S510, the charging-information modifying unit 545 modifies the charging information recorded in the corresponding CDR 540a stored in the charging-information storage unit 543. The corresponding CDR 540a refers to a CDR 540a for the bearer of the non-forwardable DL packet relevant to the dropped-packet information. The corresponding CDR 540a also contains, in the recording period of the charging information recorded in the CDR 540a, the packet-drop time contained in the drop-packet information. In the modification in step S520, for example, the data volume of the dropped DL packet, the data volume being contained in the dropped-packet information, is subtracted from the downlink-pass data volume contained in the charging information. After step S520, the operation ends. Thereafter, the CDR 540a in which the charging information was modified as described above is transmitted to the charging-information generating apparatus 540. Based on the charging information, the charging-information generating apparatus 540 performs, for example, creation of detailed billing data for the corresponding subscriber.

As described above, in the charging system 500 according to the present embodiment, when a DL packet that passed through the charging-information generating apparatus 540 is dropped at the base-station apparatus 520 or the packet relay apparatus 530, the charging information recorded in the CDR 540a is modified. A DL packet is dropped when a DL packet is dropped at at least the base-station apparatus 520 or the packet relay apparatus 530 due to an internal factor thereof or when a DL packet is dropped because no relevant session exists due to an inter-apparatus-state mismatch. For example, the data volume of the DL packet dropped at the base-station apparatus 520 and the packet relay apparatus 530 is subtracted from the downlink-pass data volume contained in the charging information. This arrangement, therefore, may suppress charging for a DL packet dropped at the base-station apparatus 520 or the packet relay apparatus 530.

In the charging system 500 according to the present embodiment, for example, the above-described modifying scheme may be realized without changing the network connection configuration and the PCC scheme from the specifications standardized by 3GPP.

The charging system 500 according to the present embodiment may also be modified as described below.

For example, when multiple DL packets for the same bearer are dropped at each of the base-station apparatus 520 and the packet relay apparatus 530 in a given time unit (for example, in a second), dropped-packet information regarding the DL packets may be merged into one piece of dropped-packet information. In such a case, however, the dropped-packet information contains a total packet size obtained by adding the packet sizes of the dropped DL packets.

For example, the charging system 500 may be configured so as to perform service-flow-level charging control. In such a case, however, the dropped-packet information generated by the base-station apparatus 520 and the packet relay apparatus 530 contains other information in addition to the information regarding the packet-drop time and the data volume of the dropped DL packet. The other information may be information regarding the transmission-source address, the transmission-source port, the destination address, the destination port, and a protocol ID of the dropped DL packet. In such a case, in the charging-information generating apparatus 540, the information regarding the downlink-pass data volume contained in the charging information recorded in the CDR 540a is provided for each service flow based on the PCC used for a corresponding bearer. The charging-information modifying unit 545 further performs processing as follows. That is, based on the dropped-packet information received by the dropped-packet information receiving unit 544 and the PCC used for the bearer for the non-forwardable DL packet relevant to the dropped-packet information, the charging-information modifying unit 545 identifies a service flow for the DL packet. For example, the service flow is identified based on the information about the transmission-source address, the transmission-destination port, the destination address, the destination port, and the protocol ID of the DL packet, the information being contained in the dropped-packet information, as well as the PCC used for the bearer for the DL packet. The charging-information modifying unit 545 then subtracts the data volume of the dropped DL packets, the data volume being contained in the received dropped-packet information, from the downlink-pass data volume for the identified service information, the data volume being contained in the charging information recorded in the associated CDR 540a.

Each of the base-station apparatus 520 and the packet relay apparatus 530, in the charging system 500 that performs service-flow-level charging control in the manner described above, may perform processing as described below. When multiple DL packets for the same bearer are dropped at each of the base-station apparatus 520 and the packet relay apparatus 530 in a given time unit (for example, in a second), dropped-packet information regarding the DL packets may be merged into one piece of dropped-packet information. In such a case, however, the transmission-source addresses, the transmission-source ports, the destination addresses, the destination ports, and the protocol IDs of the dropped DL packets are the same. The dropped-packet information merged into one piece contains information of a total packet size obtained by adding the packet sizes of the dropped DL packets.

The charging system 500 according to the present embodiment may also be applied to, for example, a communications network (such as described below) defined by 3GPP.

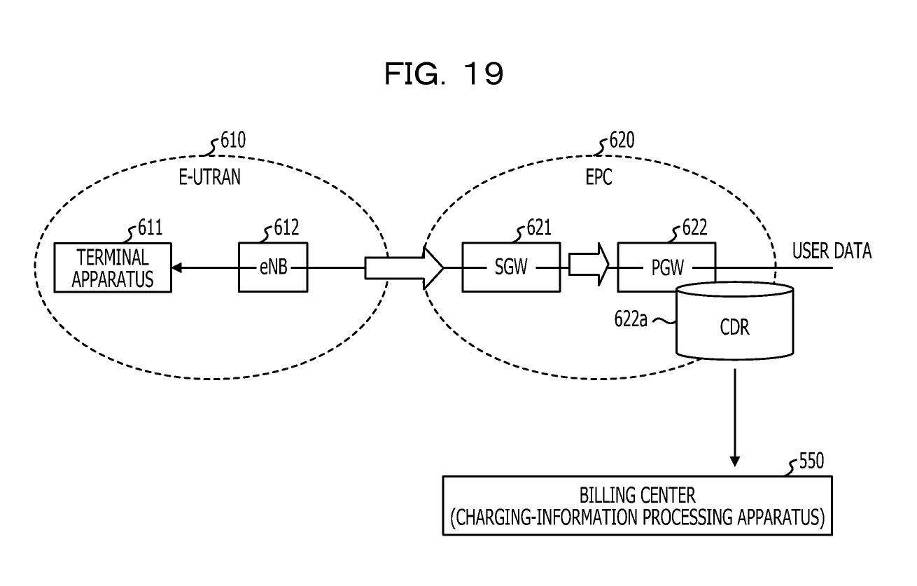

FIG. 19 illustrates an example in which the charging system 500 according to the present embodiment is applied to a communications network that includes an E-UTRAN and an EPC network. This communications network is also a communications network that includes an EPC network when an E-UTRAN is used as a wireless access network.

In the communications network illustrated in FIG. 19, in an E-UTRAN 610, a terminal apparatus 611 corresponds to the above-described terminal apparatus 510. Furthermore, an eNB 612 includes the function of the above-described base-station apparatus 520. In an EPC 620, an SGW 621 includes the function of the above-described packet relay apparatus 530. A PGW 622 includes the function of the above-described charging-information generating apparatus 540 and a CDR 622a corresponds to the above-described CDR 540a.

In the communications network illustrated in FIG. 19, the SGW 621 receives dropped-packet information transmitted from the eNB 612 and the PGW 622 receives dropped-packet information transmitted from the SGW 621. Based on the received dropped-packet information, the PGW 622 modifies the charging information recorded in the CDR 622a. An arrow from the eNB 612 to the SGW 621 and an arrow from the SGW 621 to the PGW 622 indicate flows of dropped-packet information.

As a result, charging may be suppressed for either a DL packet that is dropped at the eNB 612 or the SGW 621 in the communications network in FIG. 19 due to an internal factor thereof or a DL packet that is dropped since no relevant session exists due to an inter-apparatus-state mismatch.

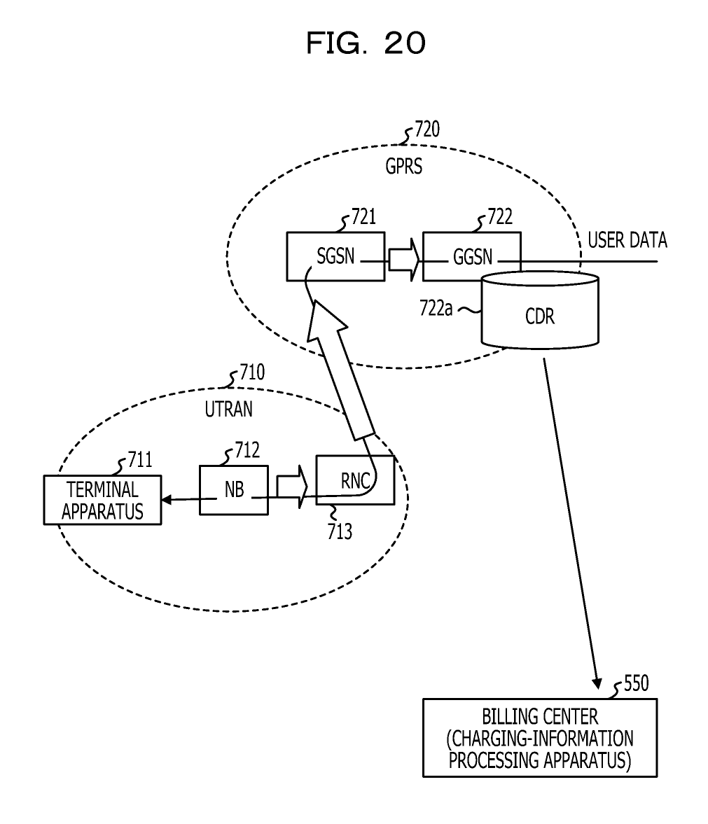

FIG. 20 illustrates an example in which the charging system 500 according to the present embodiment is applied to a communications network that includes a UTRAN and a GPRS network. This communications network is also a communications network that includes a GPRS network when a UTRAN is used as a wireless access network.

In the communications network illustrated in FIG. 20, in a UTRAN 710, a terminal apparatus 711 corresponds to the above-described terminal apparatus 510. An NB 712 includes the function of the above-described base-station apparatus 520. An RNC 713 includes the function of the above-described packet relay apparatus 530. In a GPRS 720, an SGSN 721 includes the function of the above-described packet relay apparatus 530. A GGSN 722 includes the function of the above-described charging-information generating apparatus 540 and a CDR 722a corresponds to the above-described CDR 540a.

In the communications network illustrated in FIG. 20, the RNC 713 receives dropped-packet information transmitted from the NB 712, the SGSN 721 receives dropped-packet information transmitted from the RNC 713, and the GGSN 722 receives dropped-packet information transmitted from the SGSN 721. Based on the received dropped-packet information, the GGSN 722 modifies the charging information recorded in the CDR 722a. An arrow from the NB 712 to the RNC 713, an arrow from the RNC 713 to the SGSN 721, and an arrow from the SGSN 721 to the GGSN 722 indicate flows of dropped-packet information.

As a result, charging may be suppressed for a DL packet that is dropped at the NB 712, the RNC 713, or the SGSN 721 in the communications network in FIG. 20 due to an internal factor of the apparatuses or a DL packet that is dropped because no relevant session exists due to an inter-apparatus-state mismatch.

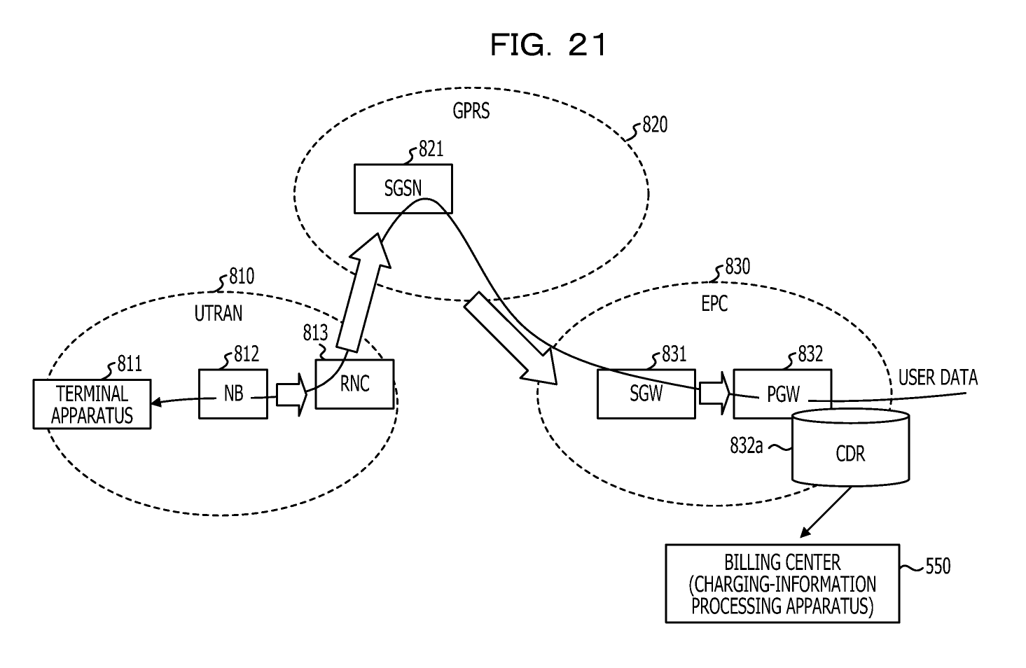

FIG. 21 illustrates an example in which the charging system 500 according to the present embodiment is applied to a communications network that includes a UTRAN, a GPRS network, and an EPC network. This communications network is also a communications network that includes an EPC network when a UTRAN is used as a wireless access network.

In the communications network illustrated in FIG. 21, in a UTRAN 810, a terminal apparatus 811 corresponds to the above-described terminal apparatus 510. An NB 812 includes the function of the above-described base-station apparatus 520. An RNC 813 includes the function of the above-described packet relay apparatus 530. In a GPRS 820, an SGSN 821 includes the function of the above-described packet relay apparatus 530. In addition, in an EPC 830, an SGW 831 includes the function of the above-described packet relay apparatus 530. A PGW 832 includes the function of the above-described charging-information generating apparatus 540, and a CDR 832a corresponds to the above-described CDR 540a.

In the communications network illustrated in FIG. 21, the RNC 813 receives dropped-packet information transmitted from the NB 812, and the SGSN 821 receives dropped-packet information transmitted from the RNC 813. Furthermore, the SGW 831 receives dropped-packet information transmitted from the SGSN 821, and the PGW 832 receives dropped-packet information transmitted from the SGW 831. Based on the received dropped-packet information, the PGW 832 modifies the charging information recorded in the CDR 832a. An arrow from the NB 812 to the RNC 813, an arrow from the RNC 813 to the SGSN 821, an arrow from the SGSN 821 to the SGW 831, and an arrow from the SGW 831 to the PGW 832 indicate flows of the dropped-packet information.

As a result, charging may be suppressed for either a DL packet that is dropped at the NB 812, the RNC 813, the SGSN 821, or the SGW 831 in the communications network in FIG. 21 due to an internal factor of the apparatus, or a DL packet that is dropped since there is no relevant session due to an inter-apparatus-state mismatch.

Thus, according to the disclosed system, apparatus, method, and program, when terminal-apparatus-addressed data that passed through the charging-information generating apparatus does not reach the terminal apparatus, it is possible to suppress charging for the data.

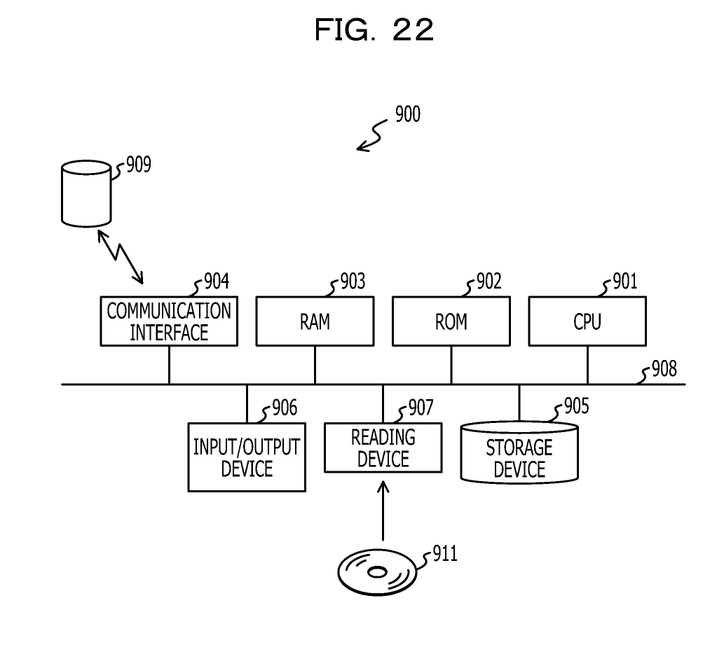

The above description has been given for the charging system 100 according to the first embodiment and the charging system 500 according to the second embodiment. The base-station apparatus 120, the packet relay apparatus 130, the charging-information generating apparatus 140, and the charging-information processing apparatus 150 included in the charging system 100 according to the first embodiment may be implemented by a computer as illustrated in FIG. 22. The base-station apparatus 520, the packet relay apparatus 530, the charging-information generating apparatus 540, and the charging-information processing apparatus 550 included in the charging system 500 according to the second embodiment may also be implemented by the computer as illustrated in FIG. 22.

FIG. 22 is a block diagram illustrating an example of a configuration of a computer.

As illustrated in FIG. 22, a computer 900 includes a central processing unit (CPU) 901, a read only memory (ROM) 902, a random access memory (RAM) 903, a communication interface 904, a storage device 905, an input/output device 906, a portable-storage-medium reading device 907, and a bus 908 to which they are connected.

The storage device 905 may be implemented by various types of storage device, such as a hard disk or a magnetic disk. A program and various types of data for operations performed by the apparatus realized by the computer 900 are stored in the storage device 905 or the ROM 902, and the program is executed by the CPU 901. The program may also be supplied from a program-supplier terminal apparatus 909 through a network 910 and the communication interface 904, be stored in the storage device 905 or the like, and be executed by the CPU 901. The program may also be stored in a commercially available, distributed portable storage medium 911, be set in the portable-storage-medium reading device 907, and be executed by the CPU 901. The portable storage medium 911 may be any of various types of storage medium, such as a compact disk read only memory (CD-ROM), a floppy disk, an optical disk, a magneto-optical disk, a digital versatile disc (DVD), or a universal serial bus (USB) memory. The input/output device 906 includes an input device and an output device. Examples of the input device include a keyboard, a pointing device, and a touch panel. Examples of the output device include a display, a printer, and a speaker.

When the computer 900 illustrated in FIG. 22 realizes the base-station apparatus 120, for example, the CPU 901 executes the program while cooperating with the communication interface 904 to thereby realize the packet forwarding unit 121 and the transmitting unit 123. In addition, for example, the CPU 901 also executes the program to thereby realize the generating unit 122.

When the computer 900 illustrated in FIG. 22 realizes the packet relay apparatus 130, for example, the CPU 901 executes the program while cooperating with the communication interface 904 to thereby realize the packet forwarding unit 131 and the transmitting unit 133. In addition, for example, the CPU 901 also executes the program to thereby realize the generating unit 132.

When the computer 900 illustrated in FIG. 22 realizes the charging-information generating apparatus 140, for example, the CPU 901 executes the program while cooperating with the communication interface 904 to thereby realize the packet forwarding unit 141 and the CDR transmitting unit 143. In addition, for example, the CPU 901 also executes the program to thereby realize the generating unit 142.

When the computer 900 illustrated in FIG. 22 realizes the charging-information processing apparatus 150, for example, the CPU 901 executes the program while cooperating with the communication interface 904 to thereby realize the receiving unit 151 and the CDR receiving unit 152. In addition, for example, the CPU 901 also executes the program to thereby realize the charging-information modifying unit 153 and the detailed-billing-data creating unit 154. The storage unit 153a is implemented by, for example, the RAM 903 or the storage device 905.

When the computer 900 illustrated in FIG. 22 realizes the base-station apparatus 520, for example, the CPU 901 executes the program while cooperating with the communication interface 904 to thereby realize the packet forwarding unit 521 and the dropped-packet information transmitting unit 525. In addition, for example, the CPU 901 executes the program to realize the dropped-packet information generating unit 522 and the dropped-packet information reading unit 524. The dropped-packet information storage unit 523 is implemented by, for example, the RAM 903 or the storage device 905.

When the computer 900 illustrated in FIG. 22 realizes the packet relay apparatus 530, for example, the CPU 901 executes the program while cooperating with the communication interface 904 to thereby realize the packet forwarding unit 531 and the dropped-packet information receiving unit 536. In addition, for example, the CPU 901 also executes the program while cooperating with the communication interface 904 to thereby realize the dropped-packet information transmitting unit 535. Furthermore, for example, the CPU 901 executes the program to realize the dropped-packet information generating unit 532, the dropped-packet information reading unit 534, and the dropped-packet information merging unit 537. The dropped-packet information storage unit 533 is also implemented by, for example, the RAM 903 or the storage device 905.

When the computer 900 illustrated in FIG. 22 realizes the charging-information generating apparatus 540, for example, the CPU 901 executes the program while cooperating with the communication interface 904 to thereby realize the packet forwarding unit 541 and the dropped-packet information transmitting unit 544. In addition, for example, the CPU 901 also executes the program while cooperating with the communication interface 904 to thereby realize the CDR transmitting unit 546. In addition, for example, the CPU 901 also executes the program to thereby realize the generating unit 542 and the charging-information modifying unit 545. The charging-information storage unit 543 is implemented by, for example, the RAM 903 or the storage device 905.

When the computer 900 illustrated in FIG. 22 realizes the charging-information processing apparatus 550, for example, the CPU 901 executes the program while cooperating with the communication interface 904, as appropriate, to thereby realize the function of the charging-information processing apparatus 550.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A charging system comprising:
a base-station apparatus;
a data relay apparatus; and
a charging-information generating apparatus,
the base-station apparatus generates first non-forwardable-data information regarding data forwarded via at least the charging-information generating apparatus and not forwarded by the base-station apparatus,
the data relay apparatus includes generates second non-forwardable-data information regarding data forwarded via at least the charging-information generating apparatus and not forwarded by the data relay apparatus,
the charging-information generating apparatus generates charging information based on data forwarded by the charging-information generating apparatus, and
the charging information is modified based on at least one of the first non-forwardable-data information and the second non-forwardable-data information.

2. The charging system according to claim 1, further comprising:
a charging-information processing apparatus;
wherein the base-station apparatus transmits the first non-forwardable-data information to the charging-information processing apparatus;
the data relay apparatus transmits the second non-forwardable-data information to the charging-information processing apparatus;
the charging-information generating apparatus transmits the charging information to the charging-information processing apparatus; and
the charging-information processing apparatus receives the charging information,
receives at least one of the first non-forwardable-data information and the second non-forwardable-data information, and
modifies the received charging information based on the received at least one of the first non-forwardable-data information and the second non-forwardable-data information.

3. The charging system according to claim 2,
wherein the base-station apparatus generates a non-forwardable-data CDR, which is a file to which non-forwardable-data information is to be recorded, and records the first non-forwardable-data information in the non-forwardable-data CDR, and transmits, to the charging-information processing apparatus, the non-forwardable-data CDR in which the first non-forwardable-data information is recorded,
the data relay apparatus generates a non-forwardable-data CDR and records the second non-forwardable-data information in the non-forwardable-data CDR, and transmits, to the charging-information processing apparatus, the non-forwardable-data CDR in which the second non-forwardable-data information is recorded,
the charging-information generating apparatus generates a CDR and records the charging information in the CDR, and
transmits, to the charging-information processing apparatus, the CDR in which the charging information is recorded; and
the charging-information processing apparatus receives the CDR, receives the non-forwardable-data CDR transmitted from at least one of the base station apparatus and the data relay apparatus, and
modifies the charging information recorded in the CDR, based on the non-forwardable-data information recorded in the non-forwardable-data CDR.

4. The charging system according to claim 1,
wherein the base-station apparatus transmits the first non-forwardable-data information to a forward-source apparatus of non-transmittable data relevant to the first non-forwardable-data information,
the data relay apparatus receives non-forwardable-data information transmitted from a forward-destination apparatus of data forwarded by the data relay apparatus, and
merges the received non-forwardable-data information and the second non-forwardable-data information,
the data relay apparatus transmits the received non-forwardable-data information, the second non-forwardable-data information, or the merged non-forwardable-data information to the forward-source apparatus of the non-forwardable data relevant to the non-forwardable-data information, and
the charging-information generating apparatus receives non-forwardable-data information transmitted from a forward-destination apparatus of data forwarded by the charging-information generating apparatus, and
modifies the generated charging information based on the non-forwardable-data information.

5. The charging system according to claim 1,
wherein the charging information contains information regarding a data volume of terminal-apparatus-addressed data forwarded by the charging-information generating apparatus,
the non-forwardable-data information contains information regarding a data volume of terminal-apparatus-addressed data forwarded via at least the charging-information generating apparatus and not forwarded to a terminal apparatus, and
subtracts the data volume of the terminal-apparatus-addressed data, the data volume being contained in the non-forwardable-data information, from the data volume of the terminal-apparatus-addressed data, the data volume being contained in the charging information.

6. A base-station apparatus comprising:
a memory; and
a processor that executes a procedure in the memory, the procedure including,
a data forwarding process that forwards data,
a generating process that generates non-forwardable-data information regarding data forwarded via at least a charging-information generating apparatus and not forwarded by the data forwarding process, the charging-information generating apparatus generating charging information based on the forwarded data, and
a transmitting process that transmits the non-forwardable-data information elsewhere,
wherein the charging information is modified based on the non-forwardable-data information.

7. The base-station apparatus according to claim 6,
wherein the generating process generates a non-forwardable-data CDR in which non-forwardable-data information is to be recorded, and records the non-forwardable-data information in the non-forwardable-data CDR, and
the transmitting process transmits, to a charging-information processing apparatus that processes a CDR in which the charging information generated by the charging-information generating apparatus is recorded, the non-forwardable-data CDR in which the non-forwardable-data information is recorded.

8. The base-station apparatus according to claim 6, wherein the transmitting process transmits the non-forwardable-data information to a forward-source apparatus of non-forwardable data relevant to the non-forwardable-data information.

9. The base-station apparatus according to claim 6, wherein the non-forwardable-data information contains information regarding a data volume of the data forwarded via at least the charging-information generating apparatus and not forwarded by the data forwarding process.

10. A data relay apparatus comprising:
a memory; and
a processor that executes a procedure in the memory, the procedure including,
a data forwarding process that forwards data,
a generating process that generates non-forwardable-data information regarding data forwarded via at least a charging-information generating apparatus and not forwarded by the data forwarding process, the charging-information generating apparatus generating charging information based on the forwarded data, and
a transmitting process that transmits the non-forwardable-data information elsewhere,
wherein the charging information is modified based on the non-forwardable-data information.

11. The data relay apparatus according to claim 10,
wherein the generating process generates a non-forwardable-data CDR in which non-forwardable-data information is to be recorded, and records the non-forwardable-data information in the non-forwardable-data CDR, and
the first transmitting process transmits, to a charging-information processing apparatus that processes a CDR in which the generated charging information is recorded, the non-forwardable-data CDR in which the non-forwardable-data information is recorded.

12. The data relay apparatus according to claim 10, wherein the procedure including,
a receiving process that receives non-forwardable-data information transmitted from a forward-destination apparatus of the data forwarded by the data forwarding process, and
a merging process that merges the received non-forwardable-data information and the generated non-forwardable-data information,
wherein the received non-forwardable-data information is information regarding terminal-apparatus-addressed data forwarded via at least the charging-information generating apparatus and the data forwarding process and not forwarded to a terminal apparatus, and
the transmitting process transmits the generated non-forwardable-data information, the received non-forwardable-data information, or the merged non-forwardable-data information to a forward-source apparatus of non-forwardable data relevant to the non-forwardable-data information.

13. The data relay apparatus according to claim 10, wherein the generated non-forwardable-data information contains information regarding a data volume of the data forwarded via at least the charging-information generating apparatus and not forwarded by the data forwarding process.

14. The data relay apparatus according to claim 12, wherein the received non-forwardable-data information contains information regarding a data volume of the terminal-apparatus-addressed data forwarded via at least the charging-information generating apparatus and the data forwarding process and not forwarded to the terminal apparatus.

15. A charging-information processing apparatus comprising:
a memory; and
a processor that executes a procedure in the memory, the procedure including,
a first receiving process that receives charging information transmitted from a charging-information generating apparatus that generates the charging information based on forwarded data,
a second receiving process that receives non-forwardable-data information transmitted from elsewhere, and
a charging-information modifying process that modifies the charging information based on the non-forwardable-data information,
wherein the non-forwardable-data information is information regarding terminal-apparatus-addressed data forwarded via at least the charging-information generating apparatus and not forwarded to a terminal apparatus.

16. The charging-information processing apparatus according to claim 15,
wherein the first receiving process receives a CDR that is a file in which the charging information is recorded, the CDR being transmitted from the charging-information generating apparatus,
the second receiving process receives a non-forwardable-data CDR that is a file in which the non-forwardable-data information is recorded, the non-forwardable-data CDR being transmitted from outside, and
the charging-information modifying process modifies the charging information recorded in the CDR, based on the non-forwardable-data information recorded in the non-forwardable-data CDR.

17. The charging-information processing apparatus according to claim 15,
wherein the charging information contains information regarding a data volume of terminal-apparatus-addressed data forwarded by the charging-information generating apparatus,
the non-forwardable-data information contains information regarding a data volume of the terminal-apparatus-addressed data forwarded via at least the charging-information generating process and not forwarded to the terminal apparatus, and
the charging-information modifying process subtracts the data volume of the terminal-apparatus-addressed data, the data volume being contained in the non-forwardable-data information, from the data volume of the terminal-apparatus-addressed data, the data volume being contained in the charging information.

18. A charging-information generating apparatus;
a memory; and
a processor that executes a procedure in the memory, the procedure including,
a data forwarding process that forwards data,
a charging-information generating process that generates charging information based on the forwarded data,
a receiving process that receives non-forwardable-data information transmitted from elsewhere,
a charging-information modifying process that modifies the charging information based on the non-forwardable-data information, and
a transmitting process that transmits one or both of the generated charging information and the modified charging information elsewhere,
wherein the non-forwardable-data information is information regarding terminal-apparatus-addressed data forwarded via at least the data forwarding process and not forwarded to a terminal apparatus.

19. The charging-information generating apparatus according to claim 18,
wherein the generated charging information contains information regarding a data volume of terminal-apparatus-addressed data forwarded by the data forwarding process,
the non-forwardable-data information contains information regarding a data volume of the terminal-apparatus-addressed data forwarded via at least the data forwarding process and not forwarded to the terminal apparatus, and
the charging-information modifying process subtracts the data volume of the terminal-apparatus-addressed data, the data volume being contained in the non-forwardable-data information, from the data volume of the terminal-apparatus-addressed data, the data volume being contained in the charging information.

20. A charging-information modifying method comprising:
generating first non-forwardable-data information regarding data forwarded via at least a charging-information generating apparatus in a charging system and not forwarded by a base-station apparatus in the charging system;
generating second non-forwardable-data information regarding data forwarded via at least the charging-information generating apparatus and not forwarded by a data relay apparatus in the charging system; and
modifying charging information generated based on data forwarded by the charging-information generating apparatus, based on at least one of the first non-forwardable-data information and the second non-forwardable-data information.
